(19) United States
(12) Patent Application Publication
(10) Pub. No.: US 2026/0370701 A1
(43) Pub. Date: Nov. 19, 2026

(54) SYSTEMS AND METHODS FOR SECURE, CONTROLLED VIRTUAL VISITATION WITH CONFINEMENT INSTITUTION INMATES

(71) Applicant: Confinement Telephony Technology, LLC, Greensboro, NC (US)

(72) Inventors: Rick Allen Lubbehusen, Winston-Salem, NC (US); John Vincent Townsend, III, Kernersville, NC (US); Edward Eugene Williams, SR., Thomasville, NC (US); Eugene Bernard Joswick, III, Marietta, GA (US); Timothy Edwin Pabon, Greensboro, NC (US)

(21) Appl. No.: 19/753,885

(22) Filed: Jul. 24, 2026

Related U.S. Application Data
(63) Continuation-in-part of application No. 18/828,068, filed on Sep. 9, 2024, now abandoned.
Application No. 18/828,068 is a continuation of application No. 18/134,200, filed on Apr. 13, 2023, now Pat. No. 12,120,160.
Application No. 18/134,200 is a division of application No. 17/523,392, filed on Nov. 10, 2021, now Pat. No. 11,757,958.
Application No. 17/523,392 is a continuation-in-part of application No. 16/383,743, filed on Apr. 15, 2019, now Pat. No. 11,201,899.
Application No. 16/383,743 is a continuation of application No. 15/956,877, filed on Apr. 19, 2018, now abandoned.
Application No. 15/956,877 is a continuation of application No. 15/625,666, filed on Jun. 16, 2017, now Pat. No. 9,979,760.
Application No. 15/625,666 is a continuation of application No. 15/162,058, filed on May 23, 2016, now Pat. No. 9,723,040.
(60) Provisional application No. 62/213,459, filed on Sep. 2, 2015.

(51) Int. Cl. H04L 65/4038; H04L 43/10; H04L 65/1069; H04L 65/1083; H04L 65/403; H04L 67/02; H04L 67/12; H04L 67/125; H04L 67/14; H04L 67/60

(52) U.S. Cl. CPC H04L 65/4038; H04L 43/10; H04L 65/1069; H04L 65/1083; H04L 65/403; H04L 67/02; H04L 67/12; H04L 67/125; H04L 67/14; H04L 67/60

(57) ABSTRACT

Secure, controlled, interactive virtual visitation for confinement institution inmates is provided using computing devices connected through a network by managing the scheduling of visitation sessions and use of shared visitation session resources, ensuring the identities of the inmate and the person with whom the inmate is to interact in the virtual visitation session, and by monitoring the interactions and communications during the virtual visitation sessions to detect prohibited activities. Another embodiment of the invention uses a virtual desktop shared from a remote server to ensure that an inmate does not have access to prohibited applications or content during a virtual visitation session.

### RELATED APPLICATIONS

This Application is a continuation-in-part of U.S. Patent Application No. 18/828,068, filed on Sep. 9, 2024, which is a continuation of U.S. Patent Application No. 18/134,200 filed on Apr. 13, 2023, which is a divisional of U.S. Patent Application No. 17/523,392 filed on Nov. 10, 2021 (now U.S. Patent No. 11,757,958 issued Sep. 12, 2023), which is a continuation-in-part of U.S. Patent Application No. 16/383,743 filed on Apr. 15, 2019 (now U.S. Patent No. 11,201,899 issued Dec. 14, 2021), which is a continuation of U.S. Patent Application No. 15/956,877 filed on April 19, 2018 (now abandoned), which is a continuation of U.S. Patent Application No. 15/625,666 filed on Jun. 16, 2017 (now U.S. Patent No. 9,979,760 issued May 22, 2018), which is a continuation of U.S. Patent Application No. 15/162,058 filed on May 23, 2016 (now U.S. Patent Number 9,723,040 issued Aug. 1, 2017), which claims the benefit of U.S. Provisional Application No. 62/213,459 filed on Sep. 2, 2015, entitled “Systems and Methods for Secure, Controlled Virtual Visitation with Confinement Institution Inmates,” each of which is incorporated herein by reference.

### FIELD OF THE INVENTION

This disclosure relates generally to electronic communications, devices, and systems used by inmates and others associated with a controlled access residential institution such as a prison or jail.

### Background

Prisoners and inmates in confinement facilities and other institutions have limited access to communicate with and interact with people outside of the institution. Such inmates can use tightly controlled phone systems to call loved ones and friends outside of the institution and can receive visitors in person. These outlets of communication and interaction fail to allow sufficient interaction to support contacts that the correctional system may want to encourage, or at least not discourage. For example, it is desirable to encourage imprisoned parents to stay in contact with their children. Encouraging such content may help prevent the parent relationship from irreconcilably deteriorating while the parent is in prison. However, it is often difficult or infeasible for an inmate to help a child with homework over the phone. In person visitation, on the other hand, allows better face-to-face interaction, but is often severely restricted in frequency and duration and far less convenient as it requires the family member to travel, and in many cases someone old enough to drive the family member, to the institution.

Businesses and recreational users use virtual meeting and virtual collaboration software to share computing device screen content with one another, interaction on virtual white boards, and otherwise collaborate during online meetings. These business/personal use-oriented virtual meeting systems, however, fail to provide adequate scheduling, control, or the level of security and monitoring that is needed in the context of prisoners and other inmates in confinement facilities. As examples, it is often desirable to ensure that an inmate who committed a crime against another individual is not able to threaten or otherwise contact the victim of that crime while in prison, to ensure that an inmate with a vendetta against a law enforcement officer, judge, or other individual is not able to threaten that person or plot revenge by contacting hit men or other persons outside of the facility, and to ensure that inmates do not plan escape or other illegal activities by contacting persons outside of the institution. Allowing inmates to use business/personal use-oriented virtual meeting systems could make it possible for the inmates to accomplish these and other types of prohibited communications without detection.

### Summary

Secure, controlled, interactive virtual visitation for confinement institution inmates is provided using computing devices connected through a network by managing the scheduling of visitation sessions and use of shared visitation session resources, ensuring the identities of the inmate and the person with whom the inmate is to interact in the virtual visitation session, and by monitoring the interactions and communications during the virtual visitation sessions to detect prohibited activities.

Various systems may be utilized to manage the scheduling of visitation sessions, authenticate participants, and monitor interactions to detect prohibited activities. Such prohibited activities include, but are not limited to, communicating in code words to plan escapes, possession of contraband items, communications that involve off-camera persons, coordinating gang-related activities, and planning assaults, riots, or other violence within the institutions. Traditional monitoring approaches—such as keyword-based text filtering, periodic screen captures, and manual review of recorded sessions may be insufficient to detect many of these and other prohibited activities. Moreover, the communication devices used to provide virtual visitation sessions (e.g., tablets, kiosks) typically capture only the audio and video needed to facilitate the visitation session itself. They do not, absent additional control, capture information about the broader physical environment in which the session is occurring. For example, an inmate may participate in a video visitation session while contraband is visible elsewhere in the room, while unauthorized persons are standing nearby providing instructions, or while the inmate’s device is located in a prohibited area of the facility. The standard audio and video shared during the session may not capture these conditions.

One embodiment of the invention monitors a virtual visitation session between an inmate of a controlled-access residential institution and a non-inmate of the institution by monitoring input on a device of the inmate and/or on a device of a non-inmate and monitoring applications in use on the devices during the virtual visitation session. A forbidden action is detected based on monitoring the input or the applications in use and the virtual visitation session is suspended, ended, or otherwise controlled based on the detected forbidden action.

One embodiment of the invention detects prohibited activities associated with a virtual visitation session involving an inmate of a controlled-access residential institution and a non-inmate on separate devices. An exemplary method comprises identifying that the virtual visitation session will occur or that the video visitation session is occurring, wherein sharing of audio and video between the inmate and the non-inmate will occur or is occurring during the virtual visitation session; based on identifying that the virtual visitation session will occur or that the video visitation session is occurring, automatically controlling a sensor to obtain additional information before, during, or after the virtual visitation session, wherein the additional information is in addition to the sensor data obtained to provide the sharing of audio and video between the inmate and the non-inmate during the virtual visitation session; detecting a prohibited activity based at least in part on the additional information obtained from the sensor; and based on detecting the prohibited activity, initiating a response to the prohibited activity.

The automatically controlled sensor may comprise, for example, an image sensor on the inmate's device (controlled to capture image data before or after the session, or with a zoom or orientation change to capture a larger or different field of view), an audio sensor on a device other than the devices of the inmate and non-inmate, a mounted security camera in the controlled-access residential institution, or a sensor on another device that is currently involved in another video visitation session and that satisfies a proximity criterion relative to the inmate's device.

The detection of prohibited activity may be performed using an artificial intelligence algorithm trained to detect prohibited behavior, contraband, weapons, drugs, violence, threat-related activity, gang-related activity, escape-related activity, or riot-related activity. In some embodiments, detection involves comparison of image data with databases of persons wanted by authorities, persons having outstanding warrants, persons suspected of gang membership, or persons having prior convictions. In some embodiments, detection involves determining whether a location of the inmate within the institution is prohibited, whether a person is participating in the session covertly, or combining information from multiple security cameras, multiple tablet devices, a jail management system, and/or an inmate location dataset.

In some embodiments, detection further involves tracking behavior patterns of the inmate to identify deviations from routine that are indicative of prohibited activity, predicting that a fight, assault, or riot is planned or about to occur, or determining a noise-based condition based on audio data from multiple devices and initiating camera recording based on that condition. A power-saving gating process may be employed in which additional sensors are activated as a likelihood of prohibited activity occurring increases over time.

The response to detected prohibited activity may comprise, for example, presenting a message requiring discontinuation of the prohibited activity for the session to continue, initiating a recording or storage of data associated with the prohibited activity, preventing display of prohibited content, or discouraging, preventing, or recording the inmate making threats, contacting victims, plotting revenge, planning an escape, or planning illegal activities.

Another embodiment of the invention provides a controlled virtual visitation session between an inmate of a controlled-access residential institution and a non-inmate of the institution. This embodiment initiates a virtual desktop on a server remote from a device of the inmate and a device of the non-inmate. The virtual desktop provides a limited set of applications, for example, without providing e-mail or Internet browser applications. The embodiment provides an image of the virtual desktop to the device of the inmate and the device of the non-inmate. The embodiment provides the virtual visitation session by iteratively receiving input from the device of the inmate or the device of the non-inmate relative to the image of the virtual desktop, changing the virtual desktop based on the received input, and providing a changed image of the changed virtual desktop to the first device of the inmate and the second device of the non-inmate. In this way, both the inmate and non-inmate can view and collaborate on documents and other content without giving the inmate access to applications on the non-inmate’s device.

Another embodiment of the invention schedules a virtual visitation session between an inmate of a controlled-access residential institution and a non-inmate of the institution. The embodiment receives a request to schedule the virtual visitation session, identifies a shared resource (e.g., tablet, private room, etc.) required for the virtual visitation session, schedules a time for the virtual visitation session based on time constraints associated with the shared resource, and notifies the inmate and non-inmate of the time scheduled for the virtual visitation session.

### BRIEF DESCRIPTION OF THE FIGURES

FIG. 1 is a flow chart illustrating an exemplary technique for scheduling inmate visitation sessions.

FIGS. 2A and 2B are flow charts illustrating an example technique for authenticating an inmate and non-inmate prior to allowing a secure, controlled, interactive virtual visitation session.

FIG. 3 is a flow chart illustrating an example technique for monitoring a virtual visitation session.

FIG. 4 is a flow chart illustrating an example technique for detecting prohibited activity during a virtual visitation session.

FIG. 5 illustrates an exemplary technique for providing a controlled virtual visitation session using a server-based virtual desktop.

FIG. 6 illustrates an exemplary virtual desktop for a virtual visitation session.

FIG. 7 is a block diagram depicting an example of a system for providing virtual visitation services to inmates of a controlled access residential institution.

FIG. 8 is a block diagram depicting example hardware implementations for the components described in FIG. 7.

### DETAILED DESCRIPTION

### A. Scheduling

The availability of inmates of an institution to participate in virtual visitation sessions is limited by the inmate’s personal obligations, restrictions, punishments, rewards, and other time constraints (e.g., the inmate may have scheduled medical appointments, etc.), as well as by the institution’s more general time constraints (e.g., all inmates may eat dinner at a specified time, etc.). In addition, if virtual visitation sessions are performed using shared electronic devices, such as computers or tablets used by multiple inmates, the use of those devices must be accounted for in scheduling the virtual visitation sessions. Further, a virtual visitation session may involve shared space, such as designated a private area to be used by different inmates at different times for virtual visitation sessions.

A computerized system is used to track inmate time constraints, institution time constraints, computer and space resource constraints, and other relevant information, and manage the scheduling, changing, and cancellation of virtual visitation sessions. In one embodiment, a scheduling module provides an interface for an inmate or non-inmate to request a time or time window for a virtual visitation session. The scheduling module then schedules the virtual visitation session (or suggests an alternative time) based on the inmate, institution, and resource constraints, and ensures that the visitation session does not violate the constraints. In one embodiment, an inmate’s personal schedule specifies the days/times the inmate is allowed to use a computing device and/or conduct a virtual visitation session. The inmate’s schedule may vary over time. For example, if the inmate is being punished for a given period of time, the inmate may be restricted from using the device during that time and thus unavailable for virtual visitations. If a visitation is already scheduled during the punishment period, the system sends an automatic notification to the non-inmate identifying that the visitation session has been cancelled or rescheduled. On the other hand, if the inmate is being rewarded for something good (e.g., good behavior, service, etc.), the inmate may get additional free time on his schedule to use in a virtual visitation session.

The management of virtual visitation sessions, in one embodiment, groups inmates into groups to facilitate fair and easier scheduling. For example, in one embodiment of the invention, specific group of inmates are designated to use shared devices at specific time(s)/date(s), e.g., group A has Monday, Wednesday, and Friday, and group B has Tuesday, Thursday, and Saturday, etc.

The scheduling system can also account for various scheduling rules or priorities. For example, inmates being rewarded for good behavior may be given access to times, devices, and private accommodations that other inmates are not given. In another example, the system implements rules to ensure that inmates are not able to monopolize virtual visitation resources using force, intimidation, or resource hoarding techniques. In one example, inmates who have not used the virtual visitation session within a certain time frame (e.g., a week, two weeks, etc.) are given access to times, devices, and private accommodations that other inmates are not given. In another embodiment, an inmate is only allowed to schedule a certain number of sessions at a given time (e.g., can only schedule two per week and can’t schedule a next session until the current week’s reservations are completed). If scheduled virtual visitation sessions are not used, the inmate can be further restricted, e.g., allowed to only schedule one or none per week. Such scheduling restrictions and controls prevent one or several inmates from monopolizing the use of the virtual visitation resources.

Schedules can also be used to facilitate the monitoring of inmate virtual visitation activity. In one example, the system is configured to notify investigators and/or officers of upcoming and/or ongoing virtual visitation sessions, so those persons can coordinate monitoring of the sessions in real time, if desired, or review later based on recordings of the sessions. Reports of current/past schedules may be available for inmates/non-inmates on a variety of devices with alerts for everyone interested in the virtual visitation sessions. Similarly, an inmate’s attendance in a virtual visitation session can be tracked and used to report deviant behavior, e.g., when an inmate begins skipping counseling or education sessions.

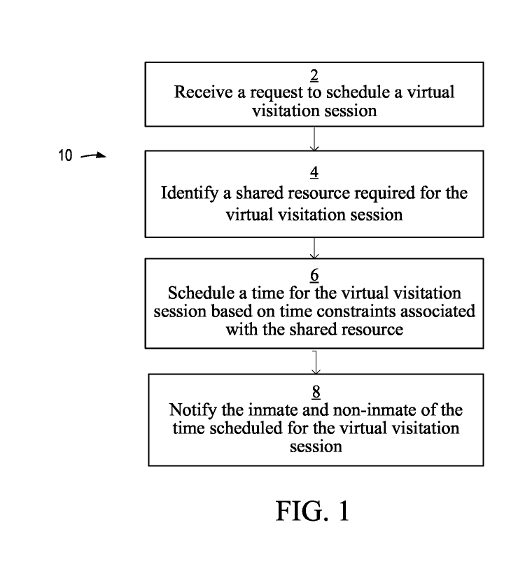

FIG. 1 is a flow chart illustrating an exemplary technique 10 for scheduling inmate visitation sessions. The technique 10 involves receiving a request to schedule a virtual visitation session, as shown in block 2. The request can be received from the inmate or the non-inmate. The technique 10 identifies a shared resource required for the virtual visitation session, as shown in block 4. In one example, the shared resource is a tablet or other computing device shared by multiple inmates. In another example, the shared resource is small room or other relatively-private space within the institution. The technique 10 further involves scheduling a time for the virtual visitation session based on time constraints associated with the shared resource, as shown in block 6, and notifying the inmate and non-inmate of the time scheduled for the virtual visitation session, as shown in block 8.

Scheduling the time for the virtual visitation session is additionally or alternatively based on an inmate time constraint (e.g., the inmate’s work schedule) and/or an institution time constraint (the institution’s lunch schedule). In another embodiment of the invention, the scheduling is additionally or alternatively based on inmate behavior. For example, inmates recognized for good behavior will have time slots available to them that are not available to inmates recognized for bad behavior. Similarly, in another embodiment of the invention, the scheduling is additionally or alternatively based on an anti-monopolization rule. For example, inmates who have not scheduled a virtual visitation for the last two weeks, are given priority to particular time blocks for scheduling virtual visitations.

### B. Identity Authentication

Identity authentication for scheduling and conducting virtual visitation sessions uses appropriate credentials and other proofs of identity. An exemplary system will require unique passwords, use biometric authentication, use one-time credentials generated by a fob, or require multiple layers of identity authentication (e.g., requiring both a password and a fob-generated unique token be provided). Identity authentication can additionally or alternatively involve confirming that the device being used is registered to the right person and/or that the device is geographically located in a location at which the person is expected, e.g., at the person’s house.

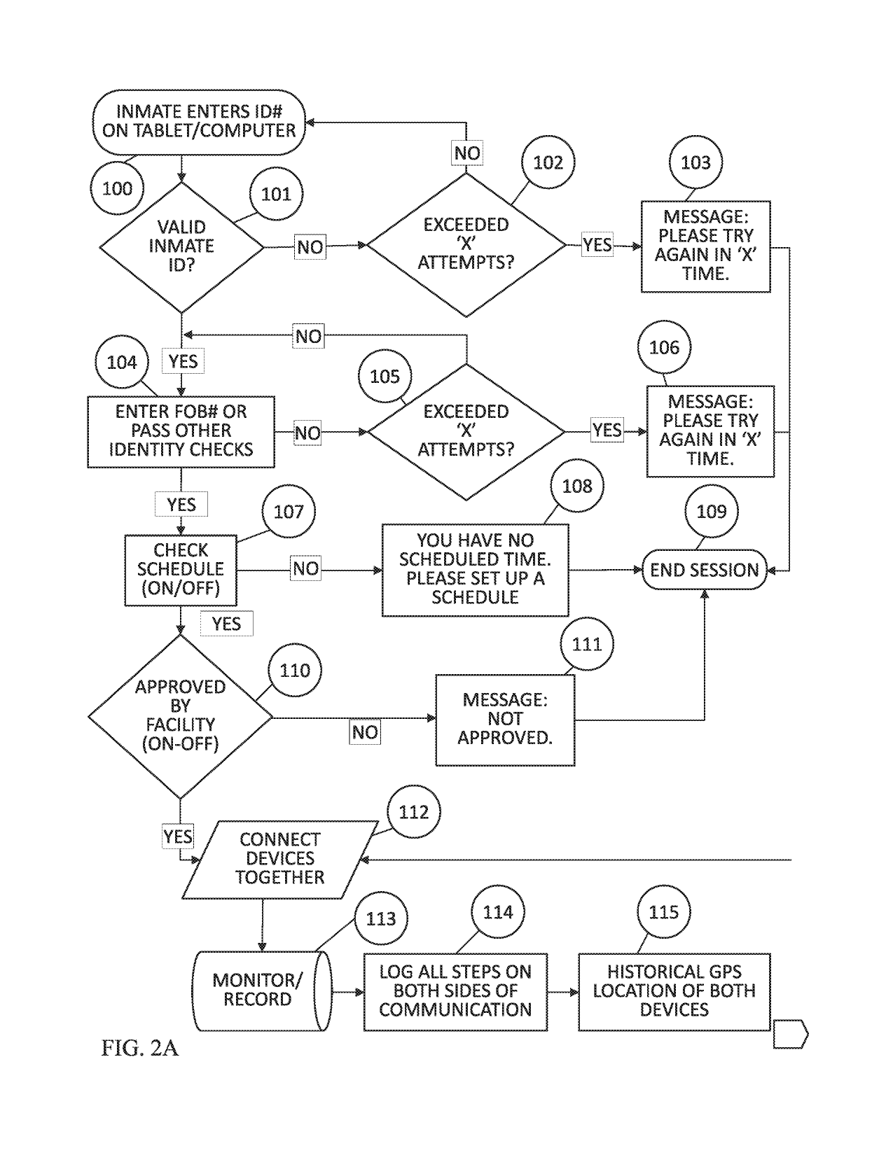

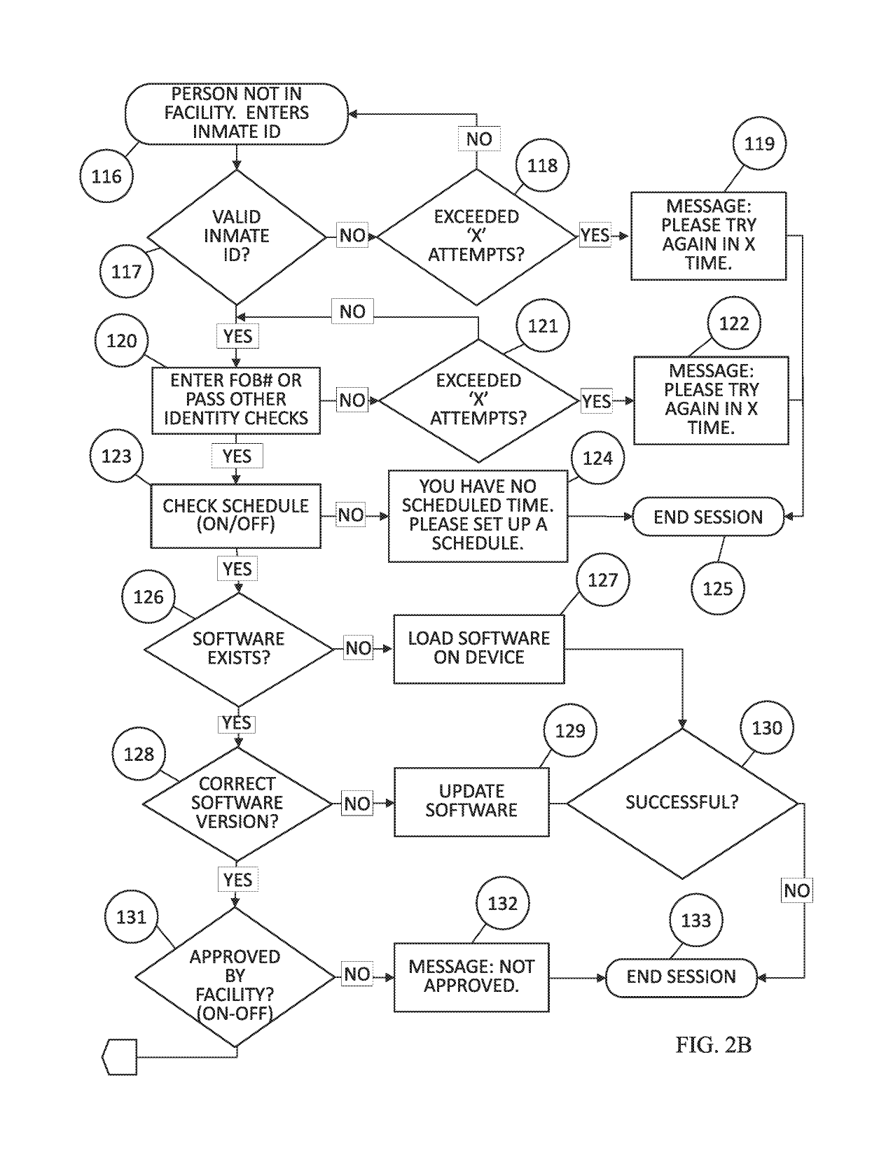

FIGS. 2A and 2B illustrate an exemplary process of authenticating the inmate and non-inmate prior to allowing a secure, controlled, interactive virtual visitation session. At box 100 the inmate enters his or her Personal Identification Number (PIN) or some other identification number as assigned by the confinement institution. At box 101 the identification number is validated. Upon successful verification, the inmate is prompted to enter his or her credentials generated by a fob or some other method of identity check, such as fingerprint, iris scan, voice biometrics, etcetera at box 104. A “fob” is a device (or software application) used to generate an access code for security purposes. An example of a fob is a small hardware device that displays a randomly generated access code, which changes, periodically every 30 to 60 seconds.

If at box 101 the identification fails validation, the system checks to see how many attempts have been made at 102, and if a predefined “X” threshold has not been exceeded, the inmate is routed back to box 100 to begin the process over. If the predefined threshold of attempts has been exceeded at box 102, then the inmate is presented with a message to try again in “X” amount of time at box 103, and the session is terminated at box 109. If at box 104 the secondary form of identification is validated, the system moves to box 107 where schedules are checked to see if a prearranged schedule for virtual visitation exists (if schedules are being used in the implementation).

If the option for schedules is not turned “on,” then a meeting could start immediately if approved by the facility. If no approvals are necessary, then the devices may be immediately connected. Approvals require time by someone at the facility. If security is low, or the facility cannot spare the resources to do approvals, the facility may elect to allow virtual visitations without case-by-case approvals.

If at box 104 the secondary form of identification fails validation, at box 105 the number of validation attempts is compared to a threshold. If the threshold has not been exceeded, the inmate is routed back to box 104 to provide his or her secondary form of identification again. If at box 105 the secondary verification fails, the system moves to box 106 with a message to try again in “X” time and ends the session at box 109. At box 107 the system checks to see if the schedule option is turned “on.” If a schedule option is “on” and a schedule exists, the system checks to ensure the virtual visitation is approved by the facility at box 110. Thus, if approvals are required and the option for approvals is turned “on”, then the system connects the devices together at box 112. If at box 107 a prearranged schedule does not exist, and the option for requiring schedules is turned “on,” the inmate will receive a message that he or she needs to schedule a time at box 108, and the session is ended at box 109. If at box 110 the visitation is not approved by the facility (if the option for approvals is turned “on”), the inmate receives a message at box 111, and the session is terminated at box 109.

At box 116 the party outside of the confinement institution enters the Personal Identification Number (PIN) or other identification number of the inmate with which he or she wishes to initiate a virtual visitation. At box 117 the identification is validated. If validation is unsuccessful a threshold is validated at box 118, and if not exceeded the non-inmate is routed back to box 116 to restart the process. If at box 118 the threshold has been exceeded, the non-inmate is given a failure message at box 119, and the session is terminated at box 125. If at box 117 the validation is successful, the non-inmate is given the opportunity to enter their credentials generated by a fob or some other method of identity check, such as fingerprint, iris scan, voice biometrics, etcetera at box 120. If the secondary credentials are unsuccessful at box 121, the number of attempts is compared against a threshold at box 121. If the threshold has not been exceeded the non-inmate is taken back to 120 for another attempt. However, if at box 121 the threshold has been exceeded the non-inmate is given a failure message at box 122, and the session is terminated at box 125.

If at box 120 the secondary identification is successfully validated, the system checks to see if a virtual visitation schedule exists at box 123 (if the option for requiring schedules is turned “on”). If no scheduled exists and schedules are required, the non-inmate is given a message at box 124, and the session is terminated at box 125. If no schedules are required, then the system will proceed to box 126. If at box 123 the schedule does exist, the system will check to see if the correct software is installed at box 126. If the correct software does not exist, it is installed at box 127 and verified at box 130. If the verification is unsuccessful the session is terminated at box 133. If the software does exist at box 126, the version is compared at box 128. If the version is out of date at box 129, the updated version is installed and validated at box 130. If the system is unable to validate the software at box 130, the session is terminated at box 133. If software verification is successful at box 130, the system checks to ensure the virtual visitation has been approved by the facility at box 131 (if the option for approvals is turned “on” in box 131). If approvals are not required, the devices are connected together. If the session has not been approved, or the option for approvals is turned “on” to be approved by the facility, a message is provided at box 132, and the session is terminated at box 133. If the session has been approved at box 131 (if the option is turned “on”), the non-inmate is connected with the inmate at box 112.

### C. Monitoring

Virtual visitation sessions are controlled by monitoring the interactions and communications during the virtual visitation session to detect prohibited activities. In one example, this involves installing specialized software functionality on one or both of the devices to track input on one or both of the devices such as keystrokes on a keyboard, touch input gestures, and use of microphones, cameras and other types of recording devices connected to the computing device used to provide the virtual visitation. In another example, controlling the virtual visitation involves monitoring the applications running on one or both of the devices to ensure that prohibited applications are not running. Installing the virtual visitation session application on the devices may require that the user authorize the application to monitor input, access operating system information, and otherwise obtain authorization and capability to monitor and control the other applications that are used during the virtual visitation and control how those applications are used. For example, the software functionality may identify use of e-mail applications, web browsing applications, and screen sharing applications during a virtual visitation and disconnect the virtual visitation when such applications use is initiated or is otherwise detected.

In another embodiment, the virtual visitation is controlled and/or monitored by using dedicated devices and/or a dedicated communication network. In one example, both parties are able to access applications and/or an interface that is shared from a network server. The inmate and outside party both access the server-provided content at the same time and can see changes that the other party makes. For example, if the server provides a view of a document, each party is able to see the document as well as a cursor of the other party. For example, a son may upload a book report to the server and then both the father (inmate) and son (non-inmate), may access the server to use a word processing application provided by the server to view and/or edit the book report together. One or both parties are able to modify the document and both parties see the changed document. The server content can be accessed by one or both of the parties using both general purpose and dedicated devices. For example, the inmate may use a dedicated computer to access a webpage, authenticate using a fob or other authentication device provided to the inmate, and then view a website interface for the server-provided content. The device may require that the parties authenticate, e.g., using a fob or other authentication device, to ensure the identities of the parties are known and to permit, restrict, control, monitor, and/or track the content provided by the server accordingly. Alternatively, the inmate or outside party may use a dedicated device, designed for limited functions including accessing the server content. Other embodiments involve sharing content between the devices of the parties. In such cases, virtual visitation control and monitoring involves providing the inmate and non-inmate with access to a dedicated tablet device that has limited capabilities or restricting the use of applications on a general purpose device. The applications on both the dedicated and general purpose computing device may be restricted, fixed, or otherwise controlled in various ways. For example, the inmate may purchase a tablet computing device that does not have web-browsing, texting, or VOIP applications or capabilities. Additionally, or alternatively, the tablet may be configured to only allow access to other devices through a dedicated network and thus may be unable to access world wide web addresses on the Internet. The tablet may be configured so that its capabilities cannot be extended, i.e., new applications and network connections cannot be added. The inmate may be required to use a fob to access the limited functionality of the dedicated computing device and/or the dedicated network.

The person with whom the inmate is to interact in the virtual visitation session may be given access through a general purpose computing device or through a dedicated mobile phone, tablet, or other computing device with limited capabilities and/or that only has access to a dedicated network. In the case of a non-inmate using a general purpose device to access a virtual visitation session, access to a private network over which the session is provided may require authenticating using a fob provided to the outside person. This ensures the identity of the non-inmate. In addition, the access can be provided through an application that bases permissions, restrictions, controls, monitoring, and tracking on the identities of the participants as verified based on the authentication. In one embodiment, if a program is access using a fob for authentication on the outside or by the inmate, a program is loaded on the respective non-inmate or inmate device that would keep all parties in the session and would prevent any party from using other applications, network locations, and other restriction functionality until the session is completed.

With respect to dedicated devices, the non-inmates may purchase or rent such a device, or may go to a public or commercial location to access the dedicated device and/or dedicated network. Such a location may be separate from the institution so that the person is able to participate in the virtual visitation without having to actually visit the institution. This is particularly beneficial in circumstances in which the institution is far from the person or otherwise inconvenient to visit. As with the inmate’s device, the non-inmate’s dedicated device may also be configured to only use certain applications and/or only allow access to certain other devices or using a certain dedicated network, and the non-inmate may be required to use a fob to use the device and/or network.

Using dedicated devices and/or a dedicated network can allow the institution to ensure that the inmate’s activities during in a virtual visitation session do not violate the institution’s restrictions. The devices and network can be tightly controlled so that use of prohibited applications and access to prohibited systems is not possible using the devices and/or network.

Whether using general purpose or dedicated devices it may alternatively or additionally be desirable to record and/or monitor some of the interactive session. In one embodiment, this involves capturing and analyzing the shared electronic content or a portion of the shared electronic content. For example, a monitoring application may periodically (e.g., once per minute, once every five minutes, etc.) capture the image on the inmate’s device’s screen and use text recognition to identify inappropriate applications, communications, or network access. In another embodiment, the interactive session may have a slow share rate to facilitate content analysis to detect inappropriate content. For example, the interactive session may only share content between the device screens once every minute, two minutes, etc., so that a monitoring application can process the content to detect impropriety in between these shares.

By providing a secure, controlled virtual visitation with confinement institution inmates, the techniques herein allow inmates to interact with persons outside the institution in new and positive ways. For example, an inmate may use a virtual visitation session to simultaneously view and work on a word processing document or spreadsheet in which the inmate’s child is completing homework. The virtual visitation may provide voice communication so that the inmate can talk with the child through the homework assignment and interactively help the child with homework in the word processing document or spreadsheet. An identity authentication technique is used to confirm the identity of the child and a monitoring and control technique is used to ensure that a prohibited activity does not occur during the session.

As other examples, the inmate and a spouse, child, loved one, or friend may play an interactive game together, write a paper or read a book together, work on a legal appeal together, participate in interactive, computer-assisted devotional studies or other learning activities together.

In one example, the inmate uses a fob to authenticate the inmate’s identity to gain access to a video game on a tablet. The inmate next goes on-line to send an invite to a non-inmate to join the game. The non-inmate (e.g., a son or daughter at home) goes on-line with computer or tablet and sees invite, then enters code from the non-inmate’s fob to join game. Function can also be set up for other group sessions that allows inmate to stay in contact with friends and family members.

In another example, the inmate uses a virtual visitation session to participate in an interactive, computer-assisted learning experience. For example, the inmate can join a school that offers online lectures and be able to see presentations, hear audio, and otherwise participate in a limited, controlled way in the lecture. The inmate’s participation may be more limited than other non-inmate lecture attendees. For example, the inmate may be prohibited from posting comments that all attendees will see and may be limited to posting only to the lecturer or a particular subset of attendees. The inmate’s audio may similarly be inactive or restricted.

In another example, an inmate uses a virtual visitation session to perform tasks as an employee of an external business. For example, the inmate may be an accountant and use the virtual visitation session to perform tax form preparation interactively. Such a session may be monitored and controlled to ensure that the inmate does not conduct prohibited activities.

In another example, a visitation session can be used to allow the inmate to collaborate on a software application to help family and other non-inmates at home with day-to-day finance, bill pay and other organization tasks that may have previously been performed by the inmate prior to incarceration. The inmate may have previously taken care of paying the bills using a bill pay application and may use the virtual session to help show family members at home how to take over on the bill paying tasks.

In another example, the virtual visitation session is used to allow an inmate to perform community service or fulfill other obligations that require the inmate to interact with non-inmates through collaborative software. The use of a virtual session allows the inmate to perform such services without having personal contact with the non-inmates. This may be desirable if it is desirable to shield the non-inmates from direct personal contact for safety, health, or convenience reasons.

In another example, portable electronic devices and virtual visitation can be used to facilitate inmates re-entering society. It is challenging for counselors to stay in touch with inmates after the inmate leaves the confinement facility. For example, an inmate may use a tablet while in the confinement institution to perform virtual visitation and various other functions. The tablet is configured with software that facilities functions that are appropriate for the inmate while in the institution. After release from the institution, some or all restrictions on the device may be removed, while allowing use of the virtual communication sessions to continue. For example, if the inmate used the tablet to have virtual counseling sessions with a counselor while within the institution, the inmate may continue to use the tablet to conduct virtual visitation sessions with the counselor after release. The software may be configured to allow either the counselor or inmate to reach one another easily and with little effort. The tablet may have tracking capabilities so that the counselor can identify where the inmate’s tablet is located. In one example, a counselor works with an inmate to assist with re-entry by helping the inmate obtain a GED, sign up for funded classes at community college, and participate in anger management classes. The tablet provides a tool for the inmate to have a virtual meeting with his counselor and discuss the inmates’ progress on courses, etc. To enhance security, the counselor and the inmate could each use a fob to access the information and/or use the virtual visitation features. The ability to conduct virtual visitations can greatly extend the influence and capabilities of counselors, who are typically working with multiple inmates in different locations. The same concept would apply to Chaplains who are working with inmates on the inside and families on the outside to assist the inmate with re-entry.

Additional features assist counselors, medics, and other in-prison personnel who meet with inmates. Such support people use electronic devices to conduct virtual visitation sessions. In one example, a support person uses a device to conduct a virtual visitation session with an inmate using another device, where both are located within a single large, facility. Both parties may be required to authenticate, e.g., with a respective fob. Based on the fob authentication, the virtual visitation is permitted, controlled, restricted, monitored, and/or tracked. This provides numerous efficiencies and advantages. For example, this can save counselors considerable time especially in circumstances in which a counselor must otherwise travel to visit a number of inmates in different buildings, floors, etc.

Virtual visitation sessions can track whether inmates are performing required activities and whether support persons are adequately providing support services. For example, the system can track counselor virtual visitations to determine how many hours are actually dedicated to counselling by a counsel. In another example, the system can determine how many hours an inmate dedicated to counselling, obtaining a GED, etc. All of this tracking can be confirmed using specific authentication to verify that the party completing the required activity or support service is correct. Such information can be used to facilitate good behavior reports, parole decisions, employment decisions, etc. Similarly, trade specific class attendance (e.g., plumbing, carpentry, etc.) can be tracked to demonstrate that an inmate is adequately trained. Conversely, reports could be generated to show that an inmate has been doing nothing, and the reports will give the counselor guidance on what areas need more attention.

Another aspect of the invention provides features that responds to detection of prohibited activities during an interactive visitation session in a way that allows the session to be continued if the prohibited activity ends without allowing the inmate access to the prohibited activity content. For example, when a launch of a prohibited application is detected on a non-inmate device, the visitation can be paused, the inmate’s screen blacked out and audio communication turned off, and messages presented to either or both the inmate and non-inmate. For example, the non-inmate may receive a message that reads “Use of application XYZ is not allowed during participation in inmate visitation session. Please discontinue use of application XYZ to resume the inmate visitation session.” The inmate may be presented with a message to wait for the visitation session to resume. Blocking content on the inmate-side as opposed to the non-inmate’s side of the communication can provide certain advantages. In some implementations, it allows the functionality installed on the non-inmate’s device to be less intrusive and less likely to be blocked by a virus scanner or the like.

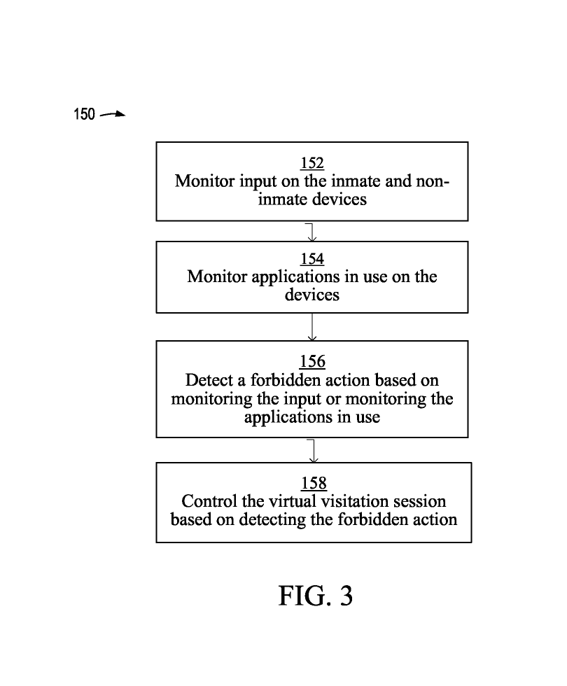

FIG. 3 illustrates an exemplary technique 150 for monitoring a virtual visitation session. The technique 150 involves monitoring input on the inmate’s device and/or the non-inmate’s device, as shown in block 152. The monitoring occurs during a virtual visitation session in which the inmate and non-inmate interact with an interface that is viewable on the device of the inmate and the device of the non-inmate. In one example, the non-inmate is able to share his or her screen or part of his or her screen with the inmate’s device. In another example, content from a particular application is shared between the devices. In another example, a separate server includes the content that is shared with the inmate’s device and the non-inmate’s device. In one example, monitoring input involves monitoring keystrokes, monitoring touch input, monitoring a microphone, monitoring a camera, and/or monitoring a recording device. Software installed on the inmate’s device, non-inmate’s device, or intermediary servers can be used to monitor the input.

The technique 150 additionally involves monitoring applications in use on the devices, as shown in block 154. This monitoring also occurs during the virtual visitation session in which the inmate and non-inmate interact with an interface that is viewable on the device of the inmate and the device of the non-inmate. The monitoring, in one example, detects use of an e-mail application, a web browsing application, and/or a screen sharing application on the device of the non-inmate during the virtual visitation session. Software installed on the inmate’s device, non-inmate’s device, or intermediary servers can be used to monitor the use of applications on the devices.

The technique 150 further involves detecting a forbidden action based on monitoring the input or monitoring the applications in use, as shown in block 156. In one embodiment of the invention, the forbidden actions are specified by the institution. For example, an institution will specify a list of forbidden applications. In another example, the forbidden actions are inmate specific. For example, one inmate will be allowed to use a banking application and another inmate will be forbidden from using the banking application during the virtual visitation sessions.

The technique 150 also involves controlling the virtual visitation session based on detecting the forbidden action. In one example, controlling the virtual visitation session based on detecting the forbidden action involves preventing the display of content associated with the forbidden action on the device of the inmate (for example by blanking out the inmate’s screen) and presenting a message regarding the forbidden action on the device of the inmate and/or the device of the non-inmate. Controlling the virtual visitation session, in one embodiment of the invention, involves capturing an image of the interface that is viewable on the device of the inmate and the device of the non-inmate and providing the image for review by a representative of the institution or law enforcement.

The monitoring of input and use of applications on the non-inmate device is based on express permission from the non-inmate in one embodiment of the invention. For example, prior to the initiation of the virtual visitation session, a popup window is used to request and receive permission from the non-inmate to monitor input and use of applications on the device of the non-inmate during the virtual visitation session.

The virtual visitations session is provided conditionally on the successful authentication of the inmate and/or non-inmate in one embodiment of the invention. In one example, authenticating the inmate involves receiving a code generated by a fob of the inmate or biometric identity information of the inmate and authenticating the non-inmate involves receiving a code generated by a fob of the non-inmate or biometric identity information of the non-inmate.

The communications and shared content of a virtual visitation session is recorded in one embodiment of the invention. Such recordings can be provided to a representative of the institution or law enforcement during and/or after the session. In one example, this involves periodically recording an image of the interface that is viewable on the first device of the inmate and the second device of the non-inmate. For example, an image can be captured every 5, 10, 20, 30, or 45 seconds, or every minute, 2 minutes, etc. Detection of suspicious activity can increase the frequency of recording images of the content of the virtual visitation session.

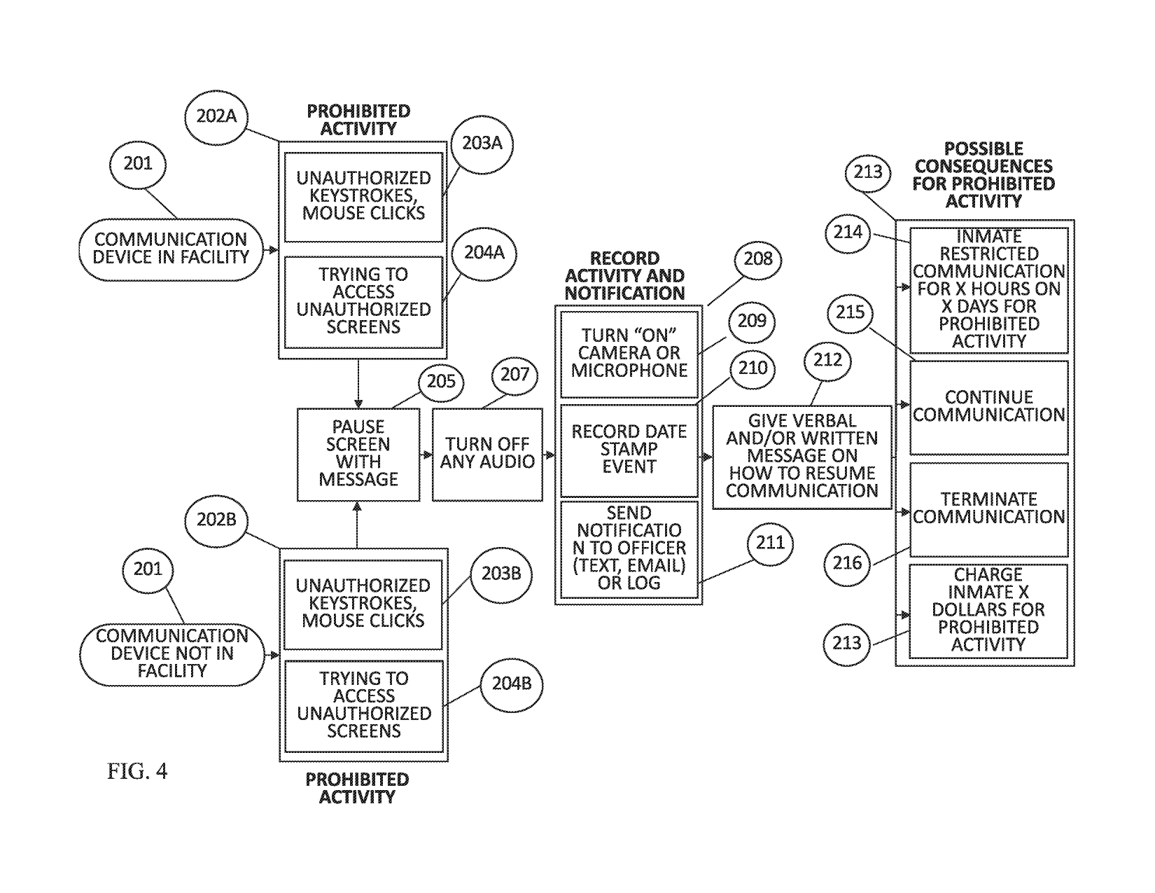

FIG. 4 illustrates an exemplary process of detecting a prohibited activity and how it is handled. At box 201 the inmate is using the device to access an application. The system recognizes this at box 202A as a prohibited activity, and the system looks at box 203A to further identify it as a unauthorized keystroke, mouse click, or possibly someone trying to get into a unauthorized screen (box 204A). Once the determined prohibited activity is identified, it is passed to box 205, and the user is given some kind of message. Then box 207 will turn off any audio and pass everything for a record activity or notification in box 208. At this point several things can happen: box 209 can turn “on” a camera or microphone to gather more, box 210 can record the information, and/or box 211 can send a notification to someone in one or more a variety of communication mediums (e-mail, text, call, etc.) or just log the event. After the recording and Notification is complete, at box 212 a message in the form of verbal and/or written response will be given to the user on how to resume communications (if allowed). Possible consequences for prohibited activity box 213 are: box 214 by restricting the inmate’s communication for a set time, box 215 allowing the communication, box 216 termination of the access, or box 213 charging the inmate x dollars for the prohibited activity.

Box 206 illustrates the same type of prohibited activity perpetrated by a non-inmate with the same effect. When the system recognizes the prohibited activity on the non-inmate side (box 202B), it will pass to box 203B and detect if it is an unauthorized keystroke, mouse click or box 204B some kind of unauthorized screen. This is passed to box 205 that will pause the screen with some kind of message. Then box 207 will turn off the audio and pass to box 208 for a record activity or notification. The camera or microphone may be turned “on” in box 209 for investigative tools, and this may include both communication devices. Then box 210 will record a date stamp of the event, and/or at box 211 a notification will be given to officer in the form of text, email, or just logged in the system. Once everything is determined, a verbal and or written message may be given to one/or both of the communication devices on how to resume communications. At box 213 the non-inmate may be given consequences for the prohibited activity. Hours and/or days of communication may be restricted (box 214), the system may allow them to continue the communication (box 215), the communication may be terminated at that point (box 216), and/or the inmate could be charged x dollars for what the non-inmate was doing (box 213).

Various techniques can be used to facilitate payment of a visitation session. In some circumstances, the inmate or non-inmate involved in the visitation session may pay for the call directly. The inmates mother, for example, may have an account for paying for telephone calls from the inmate and may be willing to apply funds from that account to pay for visitation sessions. Sponsors and advertisers can alternatively pay for (or contribute to paying for) a visitation session. For example, a group of bailbondsman or a charitable organization may contribute money to facilitate such contact between inmates and their children. In another circumstance, a visitation session is partially or entirely paid for through advertising. Graphic, video, and/or audio advertisements may be presented during the visitation session. In one embodiment, the advertisement is presented simultaneously with the visitation session. In another embodiment, the advertisement must be viewed before the visitation session starts. In another embodiment, the visitation session is paused at predefined points or intervals to present an advertisement.

In some implementations, a virtual visitation session involving an inmate of a controlled-access residential institution and a non-inmate on separate devices is provided using a method that controls the virtual visitation session. The virtual visitation session may be provided by a processor executing instructions to perform the method. For example, the method may share audio and video between the inmate and the non-inmate in the virtual visitation session. The method may include sharing a video or image of the inmate with the non-inmate and a video or image of the non-inmate with the inmate in the virtual visitation session.

The method monitors the virtual visitation session for prohibited activities. The method may, based on detecting at least one of the prohibited activities, control the virtual visitation session to discourage, record, or prevent additional occurrences of the prohibited activities.

Controlling the virtual visitation session may involve pausing the sharing of video of the virtual visitation session and presenting a message regarding the at least one of the prohibited activities on at least one of the separate devices. The message may be provided to the inmate, the non-inmate, or both. The message may require discontinuing at least one of the prohibited activities to resume the sharing of video of the virtual visitation session. In some implementations, the sharing of the audio continues while the sharing of video is paused. In some implementations, the audio is recorded while the sharing of the video is paused.

Controlling the virtual visitation session may involve preventing display of content associated with at least one of the prohibited activities on a device used by the inmate. In some implementations, controlling the virtual visitation session involves discouraging, preventing, or recording the inmate: making a threat to a law enforcement officer, a judge, or another individual; contacting a victim of a crime committed by the inmate; plotting revenge against a law enforcement officer, a judge, or other individual; planning an escape; or planning an illegal activity. In some implementations, controlling the virtual visitation session involves tracking keystrokes, touch input gestures, use of a microphone, use of a camera, or use of a recording device. In some implementations, controlling the virtual visitation session involves monitoring for use of e-mail applications, web browsing applications, and screen sharing applications.

In some implementations, a virtual visitation session involving an inmate of a controlled-access residential institution and a non-inmate on separate devices is provided using a method that controls the virtual visitation session. The virtual visitation session may be provided by a processor executing instructions to perform the method. For example, the method may share audio and video between the inmate and the non-inmate in the virtual visitation session and monitor the virtual visitation session for prohibited activities. Based on detecting at least one of the prohibited activities, the method may generate a flag identifying a starting time of a time segment during which the at least one of the prohibited activities occurred during the virtual visitation session, notify an authority of the at least one of the prohibited activities having occurred during the virtual visitation session, and/or provide direct access to the authority to a portion of a recording of the virtual visitation session based on the flag.

The direct access may be provided to the authority while the virtual visitation session is ongoing. The direct access may include a playback of the portion of the recording with an indicator added to identify an area within a recorded image associated with the at least one of the prohibited activities. The direct access may include a playback of the portion of the recording with an indicator added to identify a word, phrase, sentence, or group of sentences within recorded audio content associated with the at least one of the prohibited activities. The direct access may include a playback of the portion of the recording with a transcription of words spoken during the portion of the recording, where the transcription includes an indicator identifying a word, phrase, sentence, or group of sentences associated with the at least one of the prohibited activities. The direct access direct may include access to a snippet of less than all of a recording of the virtual visitation session to the authority, where the snippet is selected based on the flag.

### D. Server-Based Virtual Desktop

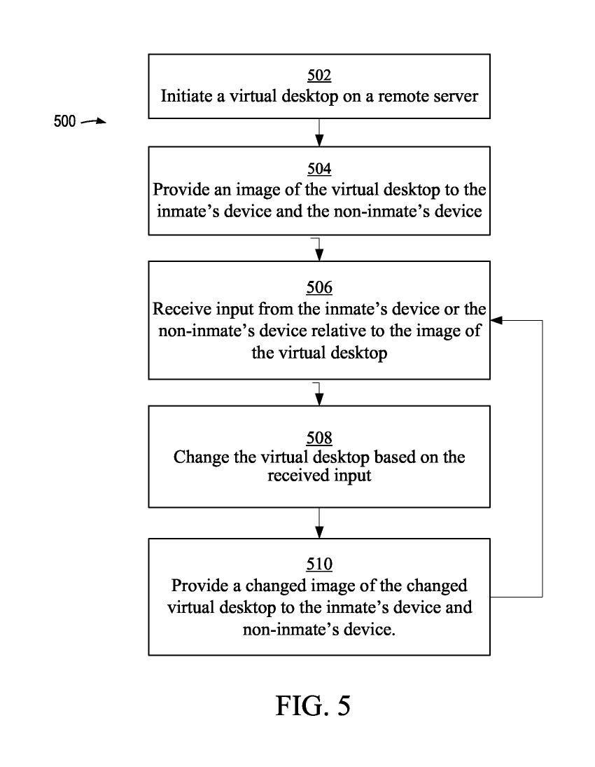

FIG. 5 illustrates an exemplary technique 500 for providing a controlled virtual visitation session using a server-based virtual desktop. The technique 500 involves initiating a virtual desktop on a remote server, as shown in block 502. The server is remote from a device of the inmate and a device of the non-inmate that will participate in the virtual visitation session. In one example, the virtual desktop provides a limited set of applications. This prevents the inmate from using the virtual visitation session to gain access to prohibited applications and content from the non-inmate’s device. In one example, the limited set of applications provided on the virtual desktop does not include applications for e-mail or accessing the Internet. The inmate and non-inmate are restricted from adding applications to the virtual desktop in one embodiment of the invention.

The technique 500 further involves providing an image of the virtual desktop to the device of the inmate and the device of the non-inmate, as shown in block 504. The technique 500 further involves providing the virtual visitation session by iteratively: receiving input from the device of the inmate or the device of the non-inmate relative to the image of the virtual desktop, as shown in block 506, changing the virtual desktop based on the received input, as shown in block 508, and providing a changed image of the changed virtual desktop to the first device of the inmate and the second device of the non-inmate, as shown in block 510.

In one embodiment of the invention, the virtual visitation session shares audio between the inmate and non-inmate. The audio can be provided using the server, provided directly between the devices of the inmate and non-inmate, or provided using other appropriate intermediary devices. Similarly, the virtual desktop further provides video conference functionality in one embodiment of the invention by including images or video of the inmate or non-inmate. The video or images can be part of the images of the desktop that are shared from the server in one example.

The virtual desktop can provide applications that allow the inmate and non-inmate to collaborate on work product. In one example, the server’s virtual desktop receives an upload of a document from the non-inmate and executes an application on the virtual desktop to display contents of the uploaded document. As a specific example, a non-inmate child uploads a book report document to work on with his father, the inmate, using a document editing application on the virtual desktop. An image of the document editing application displaying the content of the document is shared with both the non-inmate and the inmate. The inmate and non-inmate are then able to use their devices to provide input to edit the remote virtual desktop. The edits are viewable by both the inmate and non-inmate since the virtual desktop is shared with both.

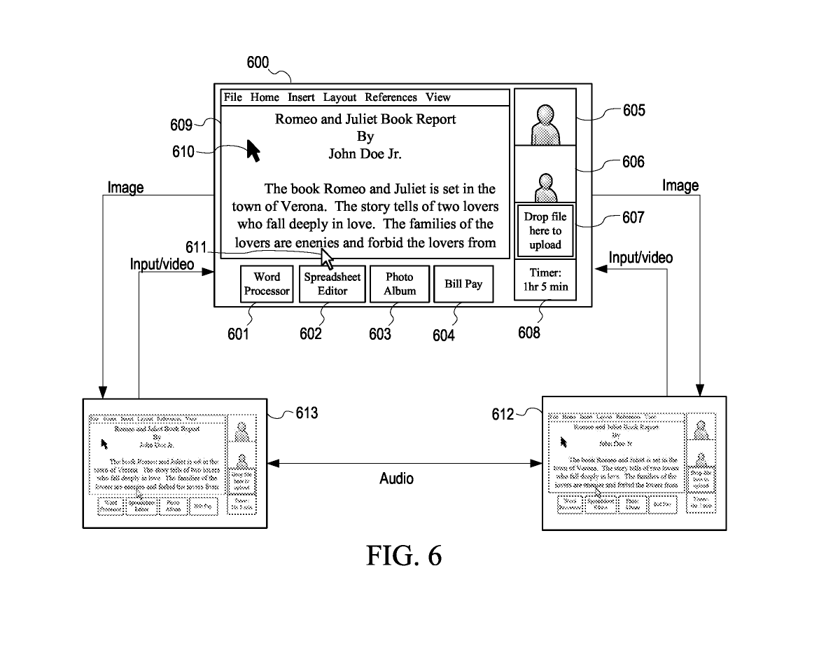

FIG. 6 illustrates an exemplary virtual desktop 600 for a virtual visitation session. In this example, the virtual desktop 600 includes a limited set of applications: a word processor 601, a spreadsheet editor 602, a photo album 603, and a bill pay application 604. The virtual desktop 600 also includes video from the inmate 605 and video from the non-inmate 606, in this example, and thus provides a video conference in addition to shared desktop content. The virtual desktop 600 also includes an upload area 607 with the label “Drop file here to upload.” The virtual desktop 600 further includes a timer 608 indicating the length of time the virtual visitation session has progressed. In this example, the virtual desktop 600 shows workspace 609 for the word processor application 601, showing content from a book report that the non-inmate has uploaded. The virtual desktop 600 also displays a cursor 610 controlled by input from the non-inmate device 612 and a cursor 611 controlled by input from the inmate device 613.

FIG. 6 illustrates that the image of the virtual desktop 600 is shared with (and displayed by) both the non-inmate device 612 and the inmate device 613. These device 612, 613 in turn are able to provide input relative to those images. For example, when the inmate moves the cursor on his own device 613, the input is provided to the virtual desktop 600, which moves the displayed cursor 611 accordingly. Mouse clicks, typing, touch input, and other types of input are similarly provided from the devices 612, 613 to allow both the inmate and non-inmate to simultaneously interact with the shared virtual desktop. In this example, audio is also shared between the device 612, 613. Thus, in the example, the inmate and non-inmate are able to talk with one another, see images of one another, and interact simultaneously with shared content on the virtual desktop 600. Other embodiments, will not include video and/or audio and/or will share the virtual interface using content rather than images.

Significantly, the inmate only has access to the content from the virtual desktop 600 and is unable to access applications (e-mail, Internet browsers, etc.) that are on the non-inmate device 612. The inmate and non-inmate cannot expand the functionality of the virtual desktop by adding applications and prohibited content items. The virtual desktop thus effectively and securely restricts the inmate’s access to only the limited set of applications that are provided on the virtual desktop 600. In the particular example of FIG. 6, the inmate is able to view the book report uploaded by the non-inmate using one of the allowed applications (i.e., the word processor 601), positions his cursor next to the misspelled word “enenies” and tells his son “it looks like you misspelled enemies here, you need to change the second n to an m.” The son hears the audio from the inmate and sees the inmate’s cursor 611 below the “n” and then makes the change by typing. The typing input is sent to the server and changes the document on virtual desktop 600. The non-inmate can later download the edited document from the virtual desktop 600.

These example uses of a virtual desktop 600 are provided merely to illustrate general principles. Numerous other uses are contemplated. For example, in another example, the inmate and non-inmate (spouse) upload and work on a spreadsheet showing the family finances. In another example, the inmate and non-inmate (counselor) upload and work on a counseling worksheet. In another example, the inmate and non-inmate (attorney) upload and review an appeal brief together. In another example, a non-inmate (family member or counselor) uploads a photo album to share memories with the inmate. Numerous other use cases are possible.

### Use of Additional Sensor Data to Monitor Inmates and Detect Prohibited Activities

The communication devices used to provide virtual visitation sessions (e.g., tablets, kiosks) typically capture only the audio and video needed to facilitate the visitation session itself. They do not, absent additional control, capture information about the broader physical environment in which the session is occurring. For example, an inmate may participate in a video visitation session while contraband is visible elsewhere in the room, while unauthorized persons are standing nearby providing instructions, or while the inmate’s device is located in a prohibited area of the facility. The standard audio and video shared during the session may not capture these conditions. There is therefore a need for systems and methods that leverage artificial intelligence and additional sensor capabilities—beyond those used to provide the audio and video sharing of the virtual visitation session itself—to detect prohibited activities before, during, and after virtual visitation sessions, and to initiate appropriate responses when prohibited activities are detected. There is a need for systems that can efficiently allocate computational and sensor resources to detection tasks, activating additional sensors and higher-accuracy detection algorithms only when initial indicators suggest that prohibited activity may be occurring. There is also a need for systems that learn from confirmed prohibited activities to improve detection accuracy over time.

Some implementations disclosed herein provide methods of detecting prohibited activities associated with a virtual visitation session involving an inmate of a controlled-access residential institution and a non-inmate on separate devices. An exemplary method comprises identifying that the virtual visitation session will occur or that the video visitation session is occurring, wherein sharing of audio and video between the inmate and the non-inmate will occur or is occurring during the virtual visitation session; based on identifying that the virtual visitation session will occur or that the video visitation session is occurring, automatically controlling a sensor to obtain additional information before, during, or after the virtual visitation session, wherein the additional information is in addition to the sensor data obtained to provide the sharing of audio and video between the inmate and the non-inmate during the virtual visitation session; detecting a prohibited activity based at least in part on the additional information obtained from the sensor; and based on detecting the prohibited activity, initiating a response to the prohibited activity.

As used in the present application, a "virtual visitation session" (also referred to as a "video visitation session") refers to an electronic communication session between an inmate of a controlled-access residential institution and a non-inmate, in which audio and video are shared between the participants using computing devices connected through a network. The terms "prohibited activity" and "forbidden action" are used interchangeably to refer to any activity that is not permitted by the rules, policies, or regulations of the controlled-access residential institution, or that is otherwise unlawful. A "sensor" includes any hardware or software component capable of capturing image data, audio data, location data, or other environmental data.

### AI-Based Detection of Prohibited Activity

In one embodiment, detecting a prohibited activity based at least in part on additional information obtained from a sensor comprises utilizing an artificial intelligence algorithm trained to detect prohibited behavior, contraband, weapons, drugs, violence, threat-related activity, gang-related activity, escape-related activity, or riot-related activity. The artificial intelligence algorithm may comprise one or more machine learning models, including but not limited to convolutional neural networks (CNNs) for image analysis, recurrent neural networks (RNNs) or transformer-based models for audio and speech analysis, natural language processing (NLP) models for analyzing transcribed speech, and multi-modal models that analyze both visual and audio inputs in combination.

In one embodiment, the artificial intelligence algorithm receives as input video data depicting one or more participants in the virtual visitation session and audio data that can be converted into text. The algorithm is trained to understand enough about what is occurring during the session to detect prohibited behaviors, including gestures, display of contraband or weapons, coded language, and other indicators of prohibited activity. Key factors indicative of prohibited activity can be detected via the artificial intelligence algorithm in real time or near real time.

In one embodiment, the artificial intelligence algorithm is trained to detect one or more of the following categories of prohibited activity: (a) display or possession of contraband items, including weapons (e.g., guns, knives, shanks), drugs or drug paraphernalia, unauthorized electronic devices, or other items prohibited within the controlled-access residential institution; (b) gang-related activity, including display of gang signs, gestures, colors, or symbols, discussion of gang membership or gang operations using plain language or code words, and interactions with known or suspected gang members; (c) escape-related activity, including discussion of escape plans, identification of facility vulnerabilities, coordination with outside confederates, and examination of facility layout or security procedures; (d) violence-related activity, including threats against law enforcement officers, judges, other inmates, or other individuals, planning of assaults, batteries, or riots, and coordination of retaliatory actions; (e) nudity or sexually explicit behavior; (f) drug transactions or coordination of smuggling operations; and (g) contact with prohibited persons, such as crime victims.

In some embodiments, inmates use code words, slang, or other obfuscated language to conduct prohibited communications during virtual visitation sessions. The artificial intelligence algorithm may be trained to detect patterns of speech that are indicative of the use of code words or otherwise deviate from normal conversational patterns. The algorithm may maintain a database of known code words, slang terms, and obfuscation patterns that are associated with prohibited activities within controlled-access residential institutions, and may update this database over time as new patterns are identified and confirmed.

In one embodiment, the system provides a group virtual visitation session in the form of a chatroom in which multiple non-inmates may participate in a discussion with an inmate simultaneously. The artificial intelligence algorithm monitors the chatroom communications—including text-based messages, audio, and video—to detect indicators of prohibited activity such as discussing escaped inmates, planning escapes, coordinating gang activities, or planning illegal acts. The monitoring of group virtual visitation sessions may apply the same detection techniques described herein for one-on-one sessions, with additional analysis of the dynamics among multiple participants.

### Controlling Additional Sensors Before, During, and After a Virtual Visitation Session

In one embodiment, the system identifies that a virtual visitation session will occur or that a video visitation session is occurring, and based on that identification, automatically controls a sensor to obtain additional information before, during, or after the virtual visitation session. The additional information is in addition to the sensor data obtained to provide the sharing of audio and video between the inmate and the non-inmate during the virtual visitation session. That is, the system captures supplemental sensor data beyond what is needed merely to facilitate the communication between participants. The participants may be unaware that additional sensor data is being captured.

The identification that a virtual visitation session will occur may be based on a schedule of inmate calls maintained by the system. For example, the system may know, based on the schedule, who will participate in an upcoming virtual visitation session, when the session is scheduled to begin, and which device the inmate will use. Based on this scheduling information, the system may begin controlling one or more sensors to obtain additional information prior to the scheduled start time of the session. In one example, the system begins capturing image data from an image sensor on the inmate's device prior to the scheduled start time of the video visitation session, allowing the system to observe the inmate's environment before the session begins.

In one embodiment, controlling the sensor comprises capturing image data from an image sensor on a device operated by the inmate prior to a start of the video visitation session, or after a conclusion of the video visitation session. For example, the system may activate the camera on the inmate's tablet device several minutes before the session is scheduled to begin, and may continue recording for a period after the session concludes. This pre-session and post-session capture allows the system to detect prohibited activities that the inmate might engage in immediately before or after the session, such as receiving contraband that will be displayed during the session and/or concealing contraband.

In another embodiment, controlling the sensor comprises capturing image data from an image sensor on a device operated by the inmate prior to a scheduled start time of the video visitation session. The system may know, based on the session schedule, that the inmate intends to call a particular person at a particular time. Based on this knowledge, the system begins capturing audio or video data from the inmate's device before the session starts. This enables the system to detect pre-session arrangements or preparations for prohibited activity—for example, an inmate telling another nearby inmate "I am going to call this person and they are going to show me [contraband]."

In another embodiment, controlling the sensor comprises capturing video and/or audio data from a sensor on a device other than the separate devices of the inmate and non-inmate. For example, additional microphones located in the common areas, pods, or cells of the controlled-access residential institution may be activated before, during, or after a virtual visitation session to capture ambient audio that provides context about activities occurring near the inmate. This ambient audio may be analyzed by the artificial intelligence algorithm to detect conversations about prohibited activities that would not be captured by the session's own audio feed.

### Camera Zoom, Position, and Field of View Control

In one embodiment, controlling the sensor comprises capturing image data from an image sensor on a device operated by the inmate, wherein a zoom of the device is changed to capture a larger field of view (e.g., larger than the initial zoom level, larger than a standard zoom level, larger than the image area shown the virtual visitation participants, etc.). For example, during a virtual visitation session, the system may automatically control the digital zoom level of the camera on the inmate's device. An inmate may start the call with the camera zoomed in, showing primarily the inmate's face. The system may automatically zoom out to capture a wider field of view that includes more of the inmate's surroundings, potentially revealing other people present nearby, contraband items in the environment, or other indicators of prohibited activity.

In another embodiment, controlling the sensor comprises capturing image data from an image sensor on a device operated by the inmate, wherein a position or orientation of the image sensor is changed to capture a different field of view. For example, if the inmate's device includes a camera that can be physically repositioned (e.g., a camera on a swivel mount, a pan-tilt camera, or a camera whose field of view can be electronically adjusted), the system may automatically change the position or orientation of the sensor to capture areas of the environment that would not otherwise be visible in the standard video feed provided to the non-inmate.

In some embodiments, the zoom, position, or orientation changes are performed periodically, randomly, or in response to detected indicators of potential prohibited activity. For example, if the artificial intelligence algorithm detects a preliminary indicator of prohibited activity (e.g., an unusual motion or gesture), the system may respond by zooming out to obtain a broader view or repositioning the camera to examine a specific area of interest. In some embodiments, the zoom or position changes are imperceptible to the inmate—for example, when a digital zoom adjustment captures a wider field of view from the sensor but provides only the standard cropped view to the non-inmate during the session.

### Use of External/Facility Security Cameras and Multi-Device Sensor Fusion

In one embodiment, controlling the sensor comprises capturing sensor data via a mounted security camera in the controlled-access residential institution. External security cameras that are part of the facility's existing security infrastructure may be activated or directed to capture additional information about the inmate's environment before, during, or after the virtual visitation session. The initiation of such external camera capture may be based on knowledge about when the session will occur, who is supposed to participate, and where the inmate's device is located within the facility.

In one embodiment, facility security cameras are used to confirm that other participants are not hiding off-camera—that is, to detect whether persons other than the identified inmate are present near the device and potentially participating in the session covertly without being captured by the audio and video being shared between the inmate and the non-inmate during the session. By obtaining sensor data from cameras with different vantage points than the inmate's own device camera, the system can detect covert participants who position themselves outside the field of view of the device camera.

In one embodiment, the system obtains sensor data from the non-inmate's device in addition to sensors within the controlled-access residential institution. For example, with appropriate authorization and consent, the system may access the camera on the non-inmate's device to capture a wider field of view on the non-inmate's side, potentially detecting prohibited persons participating from the non-inmate's location—such as individuals wanted by authorities or persons subject to no-contact orders.

In one embodiment, controlling the sensor comprises obtaining sensor data from another device currently involved in another video visitation session within the facility, wherein the another device is determined to satisfy a proximity criterion relative to a device operated by the inmate participating in the virtual visitation session. For example, if two or more virtual visitation sessions are occurring concurrently on different devices (e.g., tablets, kiosks) in the same common area or pod, the system may use the cameras and microphones on adjacent devices to obtain additional perspectives on the environment. The proximity criterion may be based on known physical locations of the devices, signal strength measurements, or other location data.

By combining sensor data from multiple concurrent video visitation sessions occurring on nearby devices, the system can improve its understanding of the entire environment. For example, if a prohibited activity is being obscured or hidden from one device's camera, the camera on an adjacent device involved in a different session may capture a different angle that reveals the activity. The system may use information about the locations of multiple cameras and their sensor data to understand what and where various activities are happening and to predict upcoming activities such as fights or riots.

### Confirming Inmate Identity and Location; Jail Management System (JMS) Integration

In one embodiment, detecting the prohibited activity comprises determining whether a location of the inmate within the controlled-access residential institution is prohibited. For example, each tablet or kiosk used for virtual visitation sessions may have an expected location within the facility (e.g., within a specific pod or common area). If the device is determined to be in an unexpected or prohibited location, this may be indicative of prohibited activity—for example, the inmate may have moved the device to a location where monitoring is more difficult, or the device may have been handed off to a different inmate.

In one embodiment, the system triangulates the location of the tablet or other device used by the inmate. The location may be determined using radio-frequency identification (RFID) tags, Wi-Fi signal triangulation, Bluetooth beacon proximity, ultra-wideband (UWB) positioning, or other location-determination technologies. The system may track the location of the device over time and detect deviations from expected patterns. For example, if an inmate who normally participates in virtual visitation sessions from a first pod is determined to be making a call from a second pod, this deviation may indicate that the same inmate is not actually making the call, or that the inmate has moved to a prohibited area.

In one embodiment, the system uses cameras watching inmates on calls to confirm inmate locations within the facility. Since a tablet may be located anywhere in a pod, or potentially in a different pod from where it is expected, the system may use facility security cameras to visually confirm that the inmate on the call matches the inmate who is scheduled for the session and that the inmate is in an authorized location. The system may identify other inmates standing next to the inmate on the call who should not be present.

In one embodiment, detecting the prohibited activity comprises combining information from: multiple security cameras in the controlled-access residential institution; multiple tablet devices operated by inmates of the controlled-access residential institution; a jail management system (JMS) storing information about the inmates of the controlled-access residential institution; and/or an inmate location dataset comprising information about locations of the inmates within the controlled-access residential institution. The jail management system may store biographical information, photographs, housing assignments, classification levels, known associates, gang affiliations, prior disciplinary actions, and other information about each inmate. The system may compare images captured by security cameras or device cameras with JMS photographs to confirm inmate identity and detect discrepancies.

In some embodiments, the system uses image data, audio data, facial identification, voice biometric analysis, as well as camera confirmation from the facility security system to understand more about calls before, during, and after their occurrence. The system may grab feeds from one or more facility cameras and combine this information with data from the jail management system to confirm inmate identity and location over time throughout the duration of the virtual visitation session and surrounding time periods.

### Detecting Covert or Unauthorized Participants

In one embodiment, detecting the prohibited activity comprises determining whether a person is participating in the virtual visitation session covertly without being captured by the audio and video being shared between the inmate and the non-inmate during the virtual visitation session. A covert participant is a person who is present near the inmate or the non-inmate and who is participating in or influencing the session but who is not visible in the video feed or audible in the audio feed that is shared between the participants.

The system may detect covert participants on the inmate's side using facility security cameras, adjacent device cameras, or by detecting audio signatures (e.g., whispered instructions, background voices) that are captured by additional microphones but not by the primary session audio. On the non-inmate's side, the system may detect covert participants by analyzing audio for additional voices, by using the non-inmate's device camera with a widened field of view, or by detecting visual indicators such as shadows or reflections suggesting additional persons are present.

In some embodiments, the system can detect someone on the remote (non-inmate) side who should not be on the call. For example, the system may maintain a list of persons who are prohibited from communicating with the inmate (e.g., crime victims, co-defendants, persons subject to restraining orders), and may use facial recognition or voice biometric analysis on audio and video from the non-inmate's side to detect the presence of such persons.

### Chatroom / Group Virtual Visitation Monitoring

In one embodiment, the system supports a group virtual visitation in which multiple non-inmates participate simultaneously in a communication session with an inmate, for example in a chatroom or group video conference format. The artificial intelligence algorithm monitors all participants and all communications within the group session to detect indicators of prohibited activity. In a group virtual visitation session, the system may analyze the content of text messages, the audio from multiple participants, and the video feeds from multiple participants to detect patterns indicative of coordinated prohibited activity. For example, multiple participants may use coded language to discuss escape plans, or participants may display items or make gestures that are only meaningful when viewed in combination. The artificial intelligence algorithm may be trained to detect such multi-participant coordination patterns.

In some embodiments, the system monitors group virtual visitation sessions for indicators of discussion about escaped inmates, gang activities, contraband smuggling, or other prohibited topics. The monitoring may include natural language processing of transcribed audio and text messages to detect relevant keywords, phrases, or semantic patterns, even when participants use code words or circumlocutions.

### Facial Recognition and Biometric Matching Against Watch Lists and Real-Time Law Enforcement Notification

In one embodiment, detecting the prohibited activity based at least in part on the additional information obtained from the sensor comprises comparison of image data with datasets of persons wanted by authorities, persons having outstanding warrants, persons suspected of gang membership, or persons having prior convictions. The system may maintain or access one or more databases containing facial images, biometric data, and associated records for persons of interest to law enforcement or institutional security.

In one embodiment, the system performs facial recognition analysis on video feeds from the virtual visitation session—including both the inmate's device camera and any additional cameras or sensors—and compares detected faces against databases of persons wanted by authorities, persons having outstanding warrants, persons suspected of gang membership, and persons having prior convictions. If a match is detected, the system may initiate a real-time notification to law enforcement or facility security personnel that a wanted individual is currently participating in or present during a video visitation session with an inmate.

For example, if a non-inmate participant or a covert participant on the non-inmate's side is identified as having an outstanding arrest warrant, the system may immediately notify the relevant law enforcement agency, providing information about the ongoing session, the identity match, and the location from which the non-inmate is connecting (if available from device geolocation data). This enables law enforcement to potentially respond while the wanted individual is still at the known location.

In some embodiments, the facial recognition analysis is performed not only on the primary participants but also on any persons detected in the background of video feeds or captured by additional sensors. On the inmate's side, the system may identify other inmates who are present near the device and compare their identities against databases of known gang members, inmates with a history of violence, or inmates who are restricted from associating with the participant inmate.

### Behavioral Pattern Tracking and Deviation Detection

In one embodiment, detecting the prohibited activity is further based on tracking behavior patterns of the inmate to identify deviations from routine, wherein the deviations are indicative of the prohibited activity. The system may maintain a behavioral profile for each inmate that records patterns of behavior over time, including the times at which the inmate typically participates in virtual visitation sessions, the persons the inmate typically communicates with, the locations from which the inmate typically participates, the devices the inmate typically uses, and the general characteristics of the inmate's communications (e.g., typical call duration, typical emotional tone, typical language patterns).

Deviations from these established patterns may be indicative of prohibited activity. For example, if an inmate who typically makes calls from a first pod at regular times suddenly begins making calls from a different location at unusual times, this deviation may indicate that the inmate's device has been taken over by another inmate, or that the inmate is attempting to conduct prohibited activities from a less-monitored location. Similarly, if an inmate who typically communicates with family members begins communicating with previously unknown contacts, or if the inmate's language patterns suddenly change (e.g., increased use of slang, code words, or aggressive language), these deviations may trigger heightened monitoring.

In one embodiment, the location of the device and which specific tablet or kiosk is being used is tracked over time. A change in the cell or call location from which an inmate participates in virtual visitation sessions may indicate that it is not the same inmate making the call, or that the inmate has been moved or has moved to a location that facilitates prohibited activity. The system may alert facility personnel based on detected deviations from the inmate's established behavioral patterns.

### Predicting Fights, Assaults, and Riots

In one embodiment, detecting the prohibited activity comprises predicting that a fight between inmates, an inmate assault or battery, or a riot is planned or about to occur. The system may analyze information from multiple sources—including virtual visitation session audio and video, additional sensor data from facility cameras, ambient audio from multiple devices, inmate behavioral patterns, and communications analysis—to identify indicators that violent events are being planned or are imminent.

In some embodiments, the system detects pre-riot or pre-assault indicators by analyzing communications across multiple virtual visitation sessions for coordinated planning activity. For example, if multiple inmates are detected communicating with outside persons about timing, weapons, or targets in a coordinated manner, this may indicate that a group assault or riot is being planned. The system may combine this communications analysis with behavioral deviation data (e.g., unusual movement patterns, congregating in unusual areas) and environmental data (e.g., increased noise levels, unusual activity detected by security cameras) to predict violent events before they occur.

In some embodiments, the system uses information gathered from multiple concurrent video visitation sessions on devices (e.g., kiosks, tablets) throughout the facility to build a comprehensive picture of facility conditions. If patterns across multiple sessions or multiple devices suggest increasing tension, coordination of prohibited activities, or preparations for violence, the system may alert facility staff to take preventive measures.

### Noise-Threshold-Triggered Activation of Cameras and Microphones Across Devices

In one embodiment, detecting the prohibited activity comprises determining a noise-based condition based on assessing audio data from audio sensors on multiple devices within the controlled-access residential institution, and initiating camera recording on one or more inmate devices or security cameras based on the noise-based condition. For example, if audio sensors on tablets, kiosks, or other devices throughout the facility detect a noise level that exceeds a predetermined threshold, the system may automatically activate cameras on all nearby devices and security cameras to begin recording.

The noise-based condition may be triggered by, for example, sudden loud voices, sounds of physical altercation, breaking objects, alarm signals, or other audio events that are indicative of a disturbance. In some embodiments, when a noise threshold or other predetermined requirement is satisfied, all cameras turn on, all microphones turn on, or a subset of cameras and microphones in a specified area turn on to capture the event. This automated activation ensures that sensor data is captured during critical moments even if those moments were not anticipated.

In some embodiments, the noise-based condition is not limited to volume thresholds but may also include detection of specific acoustic patterns (e.g., sounds of impact, screaming, glass breaking) that the artificial intelligence algorithm has been trained to recognize as indicative of violence or other prohibited activity. The system may use multiple devices distributed throughout the facility as a network of acoustic sensors, enabling localization of the source of concerning sounds and targeted activation of visual sensors in the identified area.

### Gated/Tiered-Accuracy Detection to Conserve Compute and Sensor Resources

In one embodiment, detecting the prohibited activity is based on a power-saving gating process in which additional sensors are activated as a likelihood of prohibited activity occurring increases, wherein predictions of the likelihood of prohibited activity occurring are made over time and the additional sensors are activated based on one or more predetermined likelihood thresholds being reached. This tiered approach conserves computational resources, power, storage, and network bandwidth by not operating all sensors and all detection algorithms at full capacity at all times.

In one example, the gating process operates in multiple tiers. At a first tier, the system may perform lightweight monitoring using minimal sensor resources (e.g., standard-resolution video and audio from the session itself) and a fast, computationally efficient detection algorithm. If this first tier detects a preliminary indicator of prohibited activity (e.g., an unusual gesture, an unexpected person in the frame, a keyword in transcribed audio), the system escalates to a second tier in which additional sensors are activated (e.g., widening the camera field of view, activating external security cameras, or activating microphones on adjacent devices) and a more computationally intensive and accurate detection algorithm is applied.

If the second tier confirms or increases the likelihood assessment, the system may escalate to a third tier involving even more resources, such as real-time human review, activation of all available sensors in the area, high-resolution recording, and multi-modal analysis combining video, audio, and contextual data. Each tier may have a predetermined likelihood threshold that must be reached before escalation occurs. For example, the system may make a detection with a level of accuracy (e.g., 75% confidence that an activity is prohibited) and gate decisions about resource allocation based on that confidence level.

This gated approach uses compute, imaging, audio, and other sensor resources more efficiently than a system that operates all resources at maximum capacity at all times. It also conserves device battery life and network bandwidth, which is particularly important in facilities where devices may operate on battery power and network capacity may be limited.

### Detecting Hiding Spots, Contraband, Weapons, Drugs, and Nudity

In one embodiment, the artificial intelligence algorithm is trained to detect hiding spots for contraband within the field of view of facility cameras or device cameras. For example, if a camera captures an image of an open air vent, an unsecured ceiling tile, or another potential hiding spot, the system may flag this observation for security review. The system may detect these conditions during calls when cameras are active, identifying contraband concealment locations that might otherwise go unnoticed.

In one embodiment, the system is trained to detect specific types of contraband that may be visible in video feeds during virtual visitation sessions. For example, the artificial intelligence algorithm may be trained to recognize weapons (guns, knives, shanks, improvised weapons), drugs or drug paraphernalia, unauthorized cell phones, and other prohibited items. The system may detect such items in the inmate's environment (visible in the background of the device camera or captured by external cameras) or displayed intentionally by either participant during the session.

In one embodiment, the system detects nudity or sexually explicit behavior during the virtual visitation session. The artificial intelligence algorithm may be trained to identify exposed body parts or sexually suggestive poses and may automatically initiate a response such as blacking out the video and posting a warning to stop prohibited activity, flagging the event for investigation, recording the event, or terminating the session.

In some embodiments, the zoom control capabilities described above are used in conjunction with contraband detection. For example, if the artificial intelligence algorithm detects a potential item of interest at the periphery of the standard video frame, the system may automatically zoom out or reposition the camera to obtain a clearer view of the item for more accurate classification.

### Using Data from Other Concurrent Video Visitation Sessions/Devices for Cross-Session Understanding

In one embodiment, the system uses sensor data from devices involved in other concurrent video visitation sessions to improve its understanding of activities occurring in the environment of a particular session. For example, if two or more virtual visitation sessions are occurring at or around the same time in the same area of the facility, the system may combine visual and audio data from the cameras and microphones of all involved devices to construct a more comprehensive view of the environment.

This cross-session sensor fusion improves the system's ability to understand activities that are off-camera or otherwise being intentionally obscured in one session by using information from another concurrent session. For example, if an inmate attempts to position prohibited activity outside the field of view of the inmate's own device camera, a nearby device involved in a different session may capture the activity from a different angle. The system may use location information about multiple cameras and their respective sensor data to understand what and where various activities are happening.

In some embodiments, all devices in the facility that are capable of capturing sensor data (e.g., kiosks, tablets, wall-mounted terminals) may be used as a distributed sensor network. Even devices not currently involved in active virtual visitation sessions may contribute sensor data if a noise threshold or other triggering condition is met, as described above.

### Device/Tablet Location Tracking and Location-Based Deviation Detection

In one embodiment, the system tracks the location of devices (e.g., tablets, kiosks) used for virtual visitation sessions within the controlled-access residential institution. Location tracking may be accomplished using RFID tags attached to or integrated with the devices, Wi-Fi signal triangulation based on access points within the facility, Bluetooth Low Energy (BLE) beacons, ultra-wideband (UWB) positioning systems, or combinations thereof.

The tracked device location data is used as an input to the prohibited activity detection process. For example, detecting the prohibited activity may comprise determining whether a location of the inmate within the controlled-access residential institution is prohibited based on the tracked location of the device the inmate is using. If a device is detected in a location where virtual visitation sessions are not authorized, or in a location that is inconsistent with the inmate's assigned housing unit, this may constitute a prohibited activity or may trigger heightened monitoring.

In some embodiments, the system maintains a history of device locations over time and uses this history to detect deviations from established patterns. For example, if a particular tablet is typically used in a designated common area but is detected in a restricted area or an area associated with a different housing unit, the system may alert facility staff. Similarly, the system may track which specific tablet or device an inmate uses over time, and a change in the device used may indicate that the inmate's device has been given to or taken by another inmate.

Device location tracking may also be used to facilitate locating lost device and/or determining causation and/or a party responsible for damage to a device.

### Supplementing AI Training Data with Confirmed Prohibited Activity Notations

In one embodiment, the method further comprises receiving confirmation that an activity identified by the artificial intelligence algorithm as being prohibited is in fact prohibited; receiving a notation identifying a type or characteristic of the activity; and supplementing the training of the artificial intelligence algorithm with the sensor data and notation to improve accuracy of the artificial intelligence algorithm. This feedback loop enables the system to continuously improve its detection capabilities over time.

In some implementations, when the artificial intelligence algorithm identifies a potential prohibited activity, the system presents the relevant sensor data (e.g., video clips, audio recordings, images) to a human reviewer such as a facility security officer. The reviewer may confirm that the identified activity is indeed prohibited and may add notations describing the type or characteristics of the activity (e.g., "contraband - cell phone visible," "gang sign - [specific gang affiliation]," "weapon - knife in waistband," "nudity - upper body exposed"). The confirmed sensor data and notations are then added to the training dataset for the artificial intelligence algorithm.

In this manner, any prohibited activity that is confirmed as prohibited activity (e.g., with notations) is added to the training data to improve further AI or other detection processes. The system gets better at detecting nudity, guns, knives, drugs, and other prohibited items or behaviors over time as more confirmed examples are added to the training dataset. In some embodiments, the supplementation of training data occurs continuously as new confirmed examples are identified, resulting in periodic retraining or fine-tuning of the artificial intelligence algorithm.

### Facilitating Detainee Investigations

Some implementations facilitate investigating detainees. For example, one embodiment involves facilitating improper user, theft, or damage to communication devices such as tables. Some implementations may help identify circumstances I which a detainee obtains a communication device (e.g., by removing a tablet from a charging station) and then does not login to the device. A detainee may do so in an effort to dismantle a communication device, for example. Some implementations track device position and usage and/or obtain sensor data from which improper usage of a device is observed or can be inferred. Some implementations, involve providing information that facilitates investigating detainees that remove a tablet and do not log on as a potential risk of dismantling the tablet to obtain battery. When such a circumstance is suspected via an automatic detection algorithm or process, a corrective or investigative action may be automatically initiated. For example, detection of such circumstances may trigger the device (e.g. tablet) to start to ring, e.g., triggering a tablet to start to play an audible alarm within a predetermined number of seconds or minutes after removal from charging station if the detainee does not sign on to the tablet. Similarly, if a tablet is not involved in a log on within a specific timeframe, the system may also present an option to ring or go into investigative mode in which sensors on the device are activated, e.g., turning on the camera and/or microphone. A similar approach could also be used after or before a video visit, e.g., turning on/off camera, microphone to, etc. to obtain investigative information, identity or identities of persons near the device, etc.

### Responses and Corrective Actions to Detected Prohibited Activity

In one embodiment, based on detecting the prohibited activity, the system initiates a response to the prohibited activity. The response may take one or more forms, and the specific response may depend on the type, severity, and/or confidence level of the detected prohibited activity.

In one embodiment, the response comprises presenting a message regarding the prohibited activity on at least one of the separate devices, wherein the message requires discontinuing at least one of the prohibited activities for the virtual visitation session to continue. For example, the system may pause the sharing of video between the inmate and non-inmate, present a message to one or both participants indicating that prohibited activity has been detected, and require that the prohibited activity cease before the session will resume. During such a pause, the system may continue to record audio and/or video from the devices.

In one embodiment, the response comprises initiating a recording or storage of data associated with the prohibited activity. For example, when prohibited activity is detected, the system may begin recording higher-quality video and audio, may begin recording from additional sensors that were not previously recording, or may flag the relevant time segment of an ongoing recording for later review. The recorded data may be stored for review by facility security personnel, law enforcement, or other authorized persons.

In one embodiment, the response comprises preventing display of content associated with the prohibited activity. For example, if the non-inmate displays content on their device that is prohibited (e.g., nudity, criminal plans, documents that the inmate is not authorized to view), the system may prevent that content from being displayed on the inmate's device by blacking out the inmate's screen while leaving audio active, or by replacing the prohibited content with a notification message.

In one embodiment, the response comprises discouraging, preventing, or recording the inmate making a threat to a law enforcement officer, a judge, or another individual. The system may detect threatening language using natural language processing of transcribed audio and may respond by issuing a warning, terminating the session, or recording the threatening statements for use as evidence.

In one embodiment, the response comprises discouraging, preventing, or recording the inmate contacting a victim of a crime committed by the inmate. The system may maintain a list of prohibited contacts for each inmate and may use facial recognition or voice biometric analysis to detect when a prohibited person is participating in or present during a virtual visitation session. If a crime victim is detected, the system may flag the conversation for investigation or immediately terminate the session and notify facility security.

In one embodiment, the response comprises discouraging, preventing, or recording the inmate plotting revenge against a fellow detainee, law enforcement officer, a judge, or other individual. The artificial intelligence algorithm may be trained to detect language patterns, references to specific individuals, and contextual indicators that suggest revenge planning, and may respond by recording the relevant communications and alerting appropriate authorities.

In one embodiment, the response comprises discouraging, preventing, or recording the inmate planning an escape. The system may detect escape-related discussions by analyzing transcribed audio for relevant keywords, code words, or semantic patterns, and by monitoring for visual indicators such as examination of facility maps, discussion of guard schedules, or coordination with outside confederates. Detected escape-planning activity may be recorded and reported to facility security in real time.

In one embodiment, the response comprises discouraging, preventing, or recording the inmate planning an illegal activity. This encompasses any coordination of unlawful actions through the virtual visitation session, including but not limited to drug transactions, witness intimidation, obstruction of justice, coordination of criminal enterprises, and other unlawful activities. The system may detect such planning through natural language processing, behavioral analysis, and pattern recognition, and may respond with appropriate corrective actions as described herein.

During prohibited activities, the system may take corrective action including controlling the sharing of content. For example, the system may selectively block or filter certain portions of the shared audio or video while allowing other portions to continue, may terminate the session entirely, or may allow the session to continue while flagging for investigation and recording all data for subsequent review. The specific corrective action may be configurable by facility administrators based on the type and severity of the detected prohibited activity.

### Exemplary System

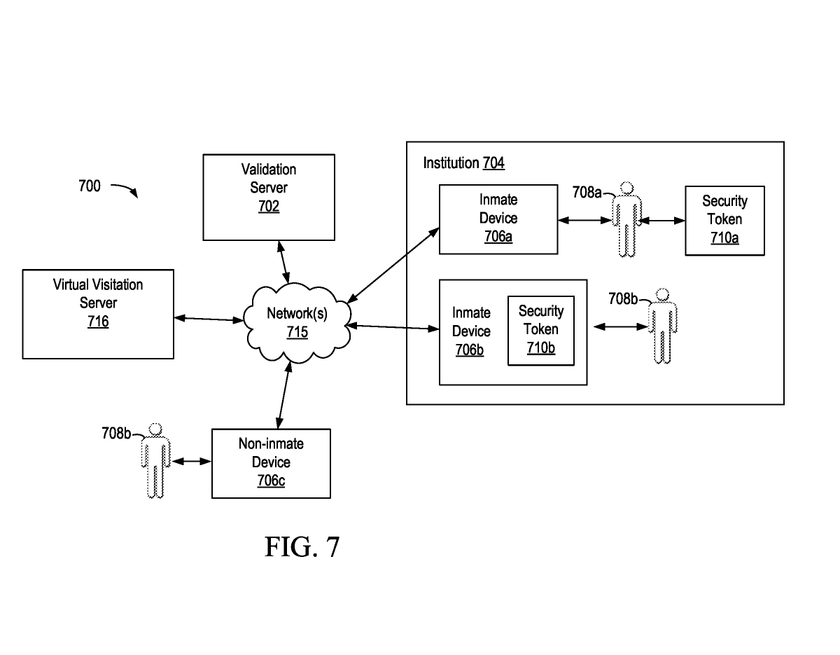

FIG. 7 is a block diagram depicting an example of a system 700 for providing services to inmates using portable electronic devices in an institution. In one embodiment a validation server 702 is used to validate a security code used by individuals 708a, 708b to use inmate devices 706a, 706b within institution 704 and personal device 706c outside of the institution 704 to conduct virtual visitation sessions. Specifically, the validation server 702, in this example, requires that entry or provision of a security code before permitting a virtual visitation session. In this example, individual 708a is an inmate of the institution who uses a security token 710a provided in a separate device to generate a security code that is entered into or provided to device 706a. The virtual visitation session from the inmate device 706a is partially or entirely restricted until the validation server 702 validates the security code. Individual 708b is an inmate of the institution who uses a security token 710a provided by an application on the inmate device 706b to generate a security code that is entered into or provided to device 706b. In one example, the individual 708b uses biometric information, such as a fingerprint scan, to obtain the security code.

Each of security tokens 710a and 710b is accessible only to the individual who has been authorized to access the respective device. Specifically, security token 710a is a device that individual 708 wears or otherwise maintains control over so that other individuals do not have access to it. If the security token 710a is lost or stolen, it can be quickly reported so that security codes generated by the security token 710a no longer work. Security token 710b is only accessible using biometric information so that other individuals cannot obtain the required security codes. The security codes can change over time (e.g., 1 time use codes, codes that change periodically, etc.). A virtual visitation session can periodically require that a fresh security code be provided to ensure that the appropriate person is still participating the virtual visitation session. In one alternative embodiment, the functionality of validation server 702 is included on each of the inmate devices 706a, 706b and/or on the personal device 706c.

Communications in the system 700 are illustrated as through network(s) 715, however, any appropriate network or communication system may be used. In this example, a virtual visitation server 716 coordinates the virtual visitation session between inmates within the institution 704 and non-inmates, such as non-inmate 708b. For example, the virtual visitation server 716 can provide audio and video conferencing between the participants. The virtual visitation server 716 can also receive content, such as a screen shared from the non-inmate’s device 706c, monitor and/or record some or all of the content, and pass the approved content on to the inmate’s device 706a, and otherwise control the virtual visitation sessions. In another embodiment of the invention, the virtual visitation server 716 provides a virtual desktop that is shared with both the non-inmate’s device 706c and the inmate’s device 706a, receives inputs from these devices 706a, 706c, alters the virtual desktop based on the inputs, and shares the updated virtual desktop with the inmate’s device 706c and the inmate’s device 706a. In another embodiment of the invention, monitoring software is installed on the inmate’s device 706c and/or the inmate’s device 706a to monitor the virtual visitation sessions that occur between the devices.

The system configuration of FIG. 7 is provided as one example of a system configuration. In a particular implementation, devices can be configured differently depending upon the particular circumstances of the implementation.

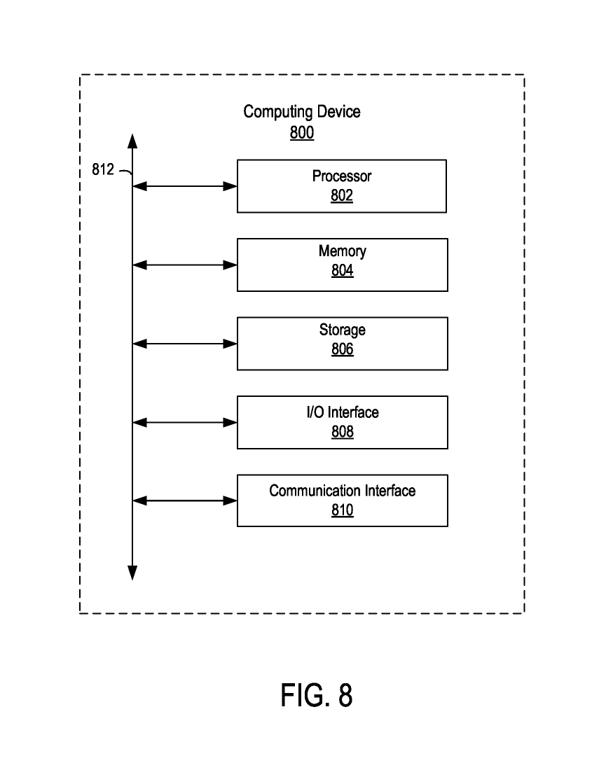

FIG. 8 is a block diagram depicting example hardware implementations for the servers and devices described in FIG. 7. Each such server or device 800 may include a processor 802 that is communicatively coupled to memory 804 and storage 806 and that executes computer-executable program code and/or access information stored in the memory 804 and storage 806. The processor 802 may comprise a microprocessor, an application-specific integrated circuit (“ASIC”), a state machine, or other processing device. The processor 802 can include any of a number of processing devices, including one. Such a processor 802 can include or may be in communication with a computer-readable medium storing instructions that, when executed by the process, cause the processor to perform the operations described herein.

The memory 804 and storage 806 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, and ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++ C#, Visual Basic, Java, Python, Perl, and JavaScript.

The device 800 may also comprise a number of external or internal devices such as input or output devices. For example, the device 800 may have input/output (“I/O”) interface 808 that can receive input from input devices or provide output to output devices. A bus 812 can also be included in the device 800. The bus 812 can communicatively couple one or more components of the server. The server can execute program code that configures the processor to perform one or more of the operations described above with respect to the Figures. The program code may be inmate in the memory or any suitable computer-readable medium and may be executed by the processor or any other suitable processor. In additional or alternative embodiments, program code can be resident in a memory that is accessible via a data network, such as a memory accessible to a cloud service.

The device 800 can also include at least one network interface device or other communication interface 810. The communication interface 810 can include any device or group of devices suitable for establishing a wired or wireless data or telephone connection to one or more networks. Non-limiting examples of a network interface device include an Ethernet network adapter, a modem, and/or the like. A device can transmit messages as electronic or optical signals.

An electronic device can be a computer, telephone, mobile device, tablet, smart phone, smart watch, or any communications device. A communications device can include a processor, memory, a bus, input/output components, network interface components, and other appropriate communication components. Non-limiting examples of input devices include a touch screen (e.g., one or more cameras for imaging a touch area or pressure sensors for detecting pressure change caused by a touch), a mouse, a keyboard, or any other device that can be used to generate input events in response to physical actions by a user of a computing device, or a microphone. Non-limiting examples of output devices include an LCD screen, an external monitor, a speaker, or any other device that can be used to display or otherwise present outputs generated by a computing device. The device can execute program code that configures the processor to perform one or more of the operations described above.

The system architecture (e.g., including a validation server, virtual visitation server, inmate devices, non-inmate devices, and network infrastructure) may be extended to include additional components for AI-based detection, sensor control, and response initiation as described herein. In some embodiments, the artificial intelligence algorithms described herein operate on edge computing devices located within the controlled-access residential institution, reducing latency for real-time detection and minimizing network bandwidth requirements for transmitting high-volume sensor data. In other embodiments, sensor data is transmitted to cloud-based or remote server-based AI processing systems for analysis. In still other embodiments, a hybrid approach is used in which lightweight, fast algorithms operate locally for initial screening and more computationally intensive algorithms operate remotely for detailed analysis when escalation is triggered.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not be described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The foregoing description and summary of the invention are to be understood as being in every respect illustrative and exemplary, but not restrictive, and the scope of the invention disclosed herein is not to be determined only from the detailed description of illustrative embodiments but according to the full breadth permitted by patent laws. It is to be understood that the embodiments shown and described herein are only illustrative of the principles of the present invention and that various modifications may be implemented by those skilled in the art without departing from the scope and spirit of the invention.

What is claimed is:

1. A method of detecting prohibited activity associated with a virtual visitation session involving an inmate of a controlled-access residential institution and a non-inmate on separate devices, the method comprising:
identifying that the virtual visitation session will occur or that the video visitation session is occurring, wherein sharing of audio and video between the inmate and the non-inmate will occur or is occurring during the virtual visitation session;
based on identifying that the virtual visitation session will occur or that the video visitation session is occurring, automatically controlling a sensor to obtain additional information before, during, or after the virtual visitation session, wherein the additional information is in addition to the sensor data obtained to provide the sharing of audio and video between the inmate and the non-inmate during the virtual visitation session;
detecting a prohibited activity based at least in part on the additional information obtained from the sensor; and
based on detecting the prohibited activity, initiating a response to the prohibited activity.

2. The method of claim 1, wherein controlling the sensor to obtain the additional information comprises capturing image data from an image sensor on a device operated by the inmate:
prior to a start of the video visitation session; or
after a conclusion of the video visitation session.

3. The method of claim 1, wherein controlling the sensor to obtain the additional information comprises capturing image data from an image sensor on a device operated by the inmate prior to a scheduled start time of the video visitation session.

4. The method of claim 1, wherein controlling the sensor to obtain the additional information comprises capturing image data from an image sensor on a device operated by the inmate, wherein a zoom of the device is changed to capture a larger field of view.

5. The method of claim 1, wherein controlling the sensor to obtain the additional information comprises capturing image data from an image sensor on a device operated by the inmate, wherein a position or orientation of the image sensor is changed to capture a different field of view.

6. The method of claim 1, wherein controlling the sensor to obtain the additional information comprises capturing audio data from an audio sensor on a device other than the separate devices of the inmate and non-inmate.

7. The method of claim 1, wherein controlling the sensor to obtain the additional information comprises capturing sensor data via a mounted security camera in the controlled-access residential institution.

8. The method of claim 1, wherein controlling the sensor to obtain the additional information comprises obtaining sensor data from another device currently involved in another video visitation session, wherein another device is determined to satisfy a proximity criterion relative to a device operated by the inmate participating in the virtual visitation session.

9. The method of claim 1, wherein detecting the prohibited activity based at least in part on the additional information obtained from the sensor comprises utilizing an artificial intelligence algorithm trained to detect prohibited behavior, contraband, weapons, drugs, violence, threat-related activity, gang-related activity, escape-related activity, or riot-related activity.

10. The method of claim 9 further comprising:
receiving confirmation that an activity identified by the artificial intelligence algorithm as being prohibited is prohibited;
receiving a notation identifying a type or characteristic of the activity; and
supplementing the training of the artificial intelligence algorithm with the sensor data and notation to improve accuracy of the artificial intelligence algorithm.

11. The method of claim 1, wherein detecting the prohibited activity based at least in part on the additional information obtained from the sensor comprises comparison of image data with datasets of persons wanted by authorities, persons have outstanding warrants, persons suspected of gang membership, or persons having prior convictions.

12. The method of claim 1, wherein detecting the prohibited activity based at least in part on the additional information obtained from the sensor comprises determining whether a location of the inmate within the controlled-access residential institution is prohibited.

13. The method of claim 1, wherein detecting the prohibited activity based at least in part on the additional information obtained from the sensor comprises determining whether a person is participating in the virtual visitation session covertly without being captured by the audio and video being shared between the inmate and the non-inmate during the virtual visitation session.

14. The method of claim 1, wherein detecting the prohibited activity based at least in part on the additional information obtained from the sensor comprises combining information from:
multiple security cameras in the controlled-access residential institution;
multiple tablet devices operated by inmates of the controlled-access residential institution;
a jail management system storing information about the inmates of the controlled-access residential institution; and
an inmate location dataset comprising information about locations of the inmates within the controlled-access residential institution.

15. The method of claim 1, wherein detecting the prohibited activity is further based on tracking behavior patterns of the inmate to identify deviations from routine, wherein the deviations are indicative of the prohibited activity.

16. The method of claim 1, wherein detecting the prohibited activity comprises predicting that a fight between inmates, an inmate assault or battery on an officer, or a riot is planned or about to occur.

17. The method of claim 1, wherein detecting the prohibited activity comprises
determining a noise-based condition based on assessing audio data from audio sensors on multiple devices within the controlled-access residential institution; and
initiating camera recording on one or more inmate devices or security cameras based on the noise-based condition.

18. The method of claim 1, wherein detecting the prohibited activity is based on a power-saving gating process in which additional sensors are activated as a likelihood of prohibited activity occurring increases, wherein predictions of the likelihood of prohibited activity occurring are made over time and the additional sensors are activated based on one or more predetermined likelihood thresholds being reached.

19. The method of claim 1, wherein the response comprises presenting a message regarding the prohibited activity on at least one of the separate devices, wherein the message requires discontinuing at least one of the prohibited activities for the virtual visitation session to continue.

20. The method of claim 1, wherein the response comprises initiating a recording or storage of data associated with the prohibited activity.

21. The method of claim 1, wherein the response comprises preventing display of content associated with the prohibited activity.

22. The method of claim 1, wherein the response comprises discouraging, preventing, or recording the inmate making a threat to a law enforcement officer, a judge, or another individual.

23. The method of claim 1, wherein the response comprises discouraging, preventing, or recording the inmate contacting a victim of a crime committed by the inmate.

24. The method of claim 1, wherein the response comprises discouraging, preventing, or recording the inmate plotting revenge against a law enforcement officer, a judge, or other individual.

25. The method of claim 1, wherein the response comprises discouraging, preventing, or recording the inmate planning an escape.

26. The method of claim 1, wherein the response comprises discouraging, preventing, or recording the inmate planning an illegal activity.
